(19) United States
(12) Patent Application Publication
(10) Pub. No.: US 2017/0085972 A1
(43) Pub. Date: Mar. 23, 2017

(54) Media Player and Media Player Design

(71) Applicant: Sonos, Inc., Santa Barbara, CA (US)

(72) Inventors: Stefan Reichert, Santa Barbara, CA (US); Mieko Kusano, Santa Barbara, CA (US); Roland Bird, Santa Barbara, CA (US); Roger Swales, Santa Barbara, CA (US); Niels van Hoof, Santa Barbara, CA (US); Lukasz Natkaniec, Santa Barbara, CA (US); Dana Krieger, Santa Barbara, CA (US); Tadeo T. Toulis, Santa Barbara, CA (US); Mike Chamness, Santa Barbara, CA (US); Hilmar Lehnert, Santa Barbara, CA (US); Wilfred Wei, Santa Barbara, CA (US); Wei Hean Liew, Santa Barbara, CA (US)

(21) Appl. No.: 14/998,017

(22) Filed: Sep. 17, 2015

(51) Int. Cl. H04R 1/02

(52) U.S. Cl. CPC H04R 1/025; H04R 1/023

(57) ABSTRACT

Media playback devices in accordance with embodiments of the invention are disclosed, including various features of the playback devices such as (but not limited to) the color of the playback devices and the appearance of feet of the playback device.

### FIELD OF THE INVENTION

The present invention relates generally to media players and more specifically to wireless speakers.

### BACKGROUND OF THE INVENTION

Technological advancements have increased the accessibility of music content, as well as other types of media, such as television content, movies, and interactive content. For example, a user can access audio, video, or both audio and video content over the Internet through an online store, an Internet radio station, a music service, a movie service, and so on, in addition to the more traditional avenues of accessing audio and video content. Demand for audio, video, and both audio and video content inside and outside of the home continues to increase.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a perspective view of a PLAYBACK DEVICE, according to a first embodiment of the invention.

FIG. 2 is another perspective view of the embodiment of FIG. 1.

FIG. 3 is another perspective view of the embodiment of FIG. 1.

FIG. 4 is a front view of the embodiment of FIG. 1.

FIG. 5 is a rear view of the embodiment of FIG. 1.

FIG. 6 is a left view of the embodiment of FIG. 1.

FIG. 7 is a right view of the embodiment of FIG. 1.

FIG. 8 is a top view of the embodiment of FIG. 1.

FIG. 9 is a bottom view of the embodiment of FIG. 1.

FIG. 10 is a perspective view of a PLAYBACK DEVICE, according to a second embodiment of the invention.

FIG. 11 is a front view of the embodiment of FIG. 10.

FIG. 12 is a close up view of the portion that is indicated in FIG. 11.

FIG. 13 is another perspective view of the embodiment of FIG. 10.

FIG. 14 is a front view of the embodiment of FIG. 10.

FIG. 15 is a rear view of the embodiment of FIG. 10.

FIG. 16 is a left view of the embodiment of FIG. 10.

FIG. 17 is a right view of the embodiment of FIG. 10.

FIG. 18 is a top view of the embodiment of FIG. 10.

FIG. 19 is a bottom view of the embodiment of FIG. 10.

FIG. 20 is a perspective view of a PLAYBACK DEVICE, according to a third embodiment of the invention.

FIG. 21 is another perspective view of the embodiment of FIG. 20.

FIG. 22 is a front view of the embodiment of FIG. 20.

FIG. 23 is a rear view of the embodiment of FIG. 20.

FIG. 24 is a left view of the embodiment of FIG. 20.

FIG. 25 is a right view of the embodiment of FIG. 20.

FIG. 26 is a top view of the embodiment of FIG. 20.

FIG. 27 is a bottom view of the embodiment of FIG. 20.

FIG. 28 is a perspective view of a PLAYBACK DEVICE, according to a fourth embodiment of the invention.

FIG. 29 is another perspective view of the embodiment of FIG. 28.

FIG. 30 is a front view of the embodiment of FIG. 28.

FIG. 31 is a rear view of the embodiment of FIG. 28.

FIG. 32 is a left view of the embodiment of FIG. 28.

FIG. 33 is a right view of the embodiment of FIG. 28.

FIG. 34 is a top view of the embodiment of FIG. 28.

FIG. 35 is a bottom view of the embodiment of FIG. 28.

FIG. 36 is a perspective view of a PLAYBACK DEVICE, according to a fifth embodiment of the invention.

FIG. 37 is another perspective view of the embodiment of FIG. 36.

FIG. 38 is a front view of the embodiment of FIG. 36.

FIG. 39 is a rear view of the embodiment of FIG. 36.

FIG. 40 is a left view of the embodiment of FIG. 36.

FIG. 41 is a right view of the embodiment of FIG. 36.

FIG. 42 is a top view of the embodiment of FIG. 36.

FIG. 43 is a bottom view of the embodiment of FIG. 36.

FIG. 44 is a perspective view of a PLAYBACK DEVICE, according to a sixth embodiment of the invention.

FIG. 45 is another perspective view of the embodiment of FIG. 44.

FIG. 46 is a front view of the embodiment of FIG. 44.

FIG. 47 is a rear view of the embodiment of FIG. 44.

FIG. 48 is a left view of the embodiment of FIG. 44.

FIG. 49 is a right view of the perspective view shown in FIG. 44.

FIG. 50 is a top view of the perspective view shown in FIG. 44.

FIG. 51 is a bottom view of the embodiment of FIG. 44.

FIG. 52 is a perspective view of a PLAYBACK DEVICE, according to a seventh embodiment of the invention.

FIG. 53 is another perspective view of the embodiment of FIG. 52.

FIG. 54 is a front view of the embodiment of FIG. 52.

FIG. 55 is a back view of the embodiment of FIG. 52.

FIG. 56 is a left view of the embodiment of FIG. 52.

FIG. 57 is a right view of the embodiment of FIG. 52.

FIG. 58 is a top view of the embodiment of FIG. 52.

FIG. 59 is a bottom view of the embodiment of FIG. 52.

FIG. 60 is a perspective view of a PLAYBACK DEVICE, according to an eighth embodiment of the invention.

FIG. 61 is another perspective view of the embodiment of FIG. 60.

FIG. 62 is a front view of the embodiment of FIG. 60.

FIG. 63 is a rear view of the embodiment of FIG. 60.

FIG. 64 is a left view of the embodiment of FIG. 60.

FIG. 65 is a right view of the embodiment of FIG. 60.

FIG. 66 is a top view of the embodiment of FIG. 60.

FIG. 67 is a bottom view of the embodiment of FIG. 60.

FIG. 68 is a perspective view of a PLAYBACK DEVICE, according to a ninth embodiment of the invention.

FIG. 69 is another perspective view of the embodiment of FIG. 68.

FIG. 70 is a front view of the embodiment of FIG. 68.

FIG. 71 is a rear view of the embodiment of FIG. 68.

FIG. 72 is a left view of the embodiment of FIG. 68.

FIG. 73 is a right view of the embodiment of FIG. 68.

FIG. 74 is a top view of the embodiment of FIG. 68.

FIG. 75 is a bottom view of the embodiment of FIG. 68.

FIG. 76 is a perspective view of a PLAYBACK DEVICE having a white casing and black front speaker screen, according to a tenth embodiment of the invention.

FIG. 77 is another perspective view of the embodiment of FIG. 76.

FIG. 78 is a front view of the embodiment of FIG. 76.

FIG. 79 is a rear view of the embodiment of FIG. 76.

FIG. 80 is a left view of the embodiment of FIG. 76.

FIG. 81 is a right view of the embodiment of FIG. 76.

FIG. 82 is a top view of the embodiment of FIG. 76.

FIG. 83 is a bottom view of the embodiment of FIG. 76.

FIG. 84 is a perspective view of a PLAYBACK DEVICE having a black casing and black front speaker screen, according to an eleventh embodiment of the invention.

FIG. 85 is another perspective view of the embodiment of FIG. 84.

FIG. 86 is a front view of the embodiment of FIG. 84.

FIG. 87 is a rear view of the embodiment of FIG. 84.

FIG. 88 is a left view of the embodiment of FIG. 84.

FIG. 89 is a right view of the embodiment of FIG. 84.

FIG. 90 is a top view of the embodiment of FIG. 84.

FIG. 91 is a bottom view of the embodiment of FIG. 84.

### DETAILED DESCRIPTION

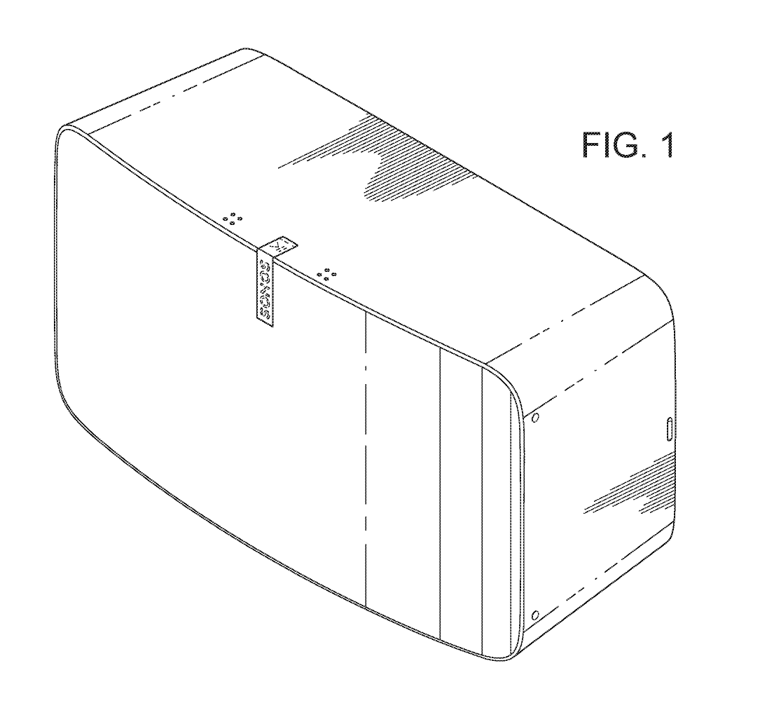

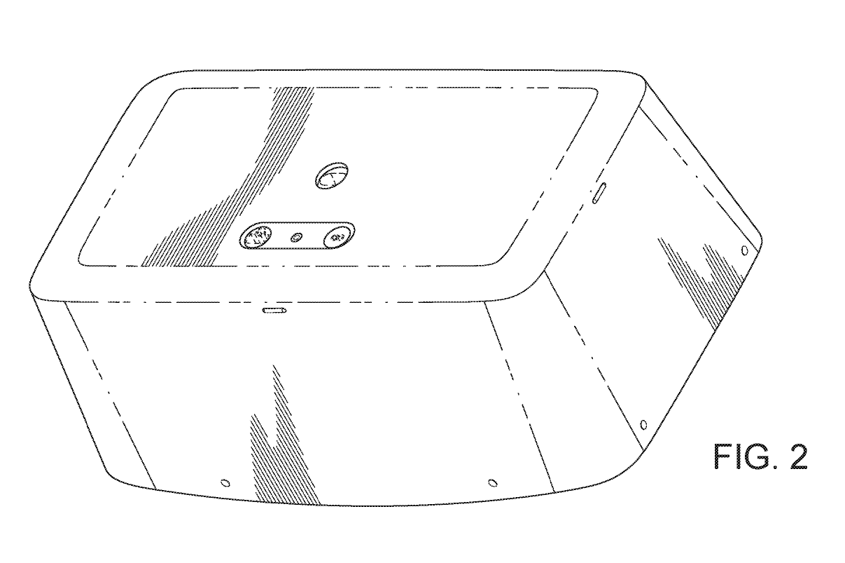

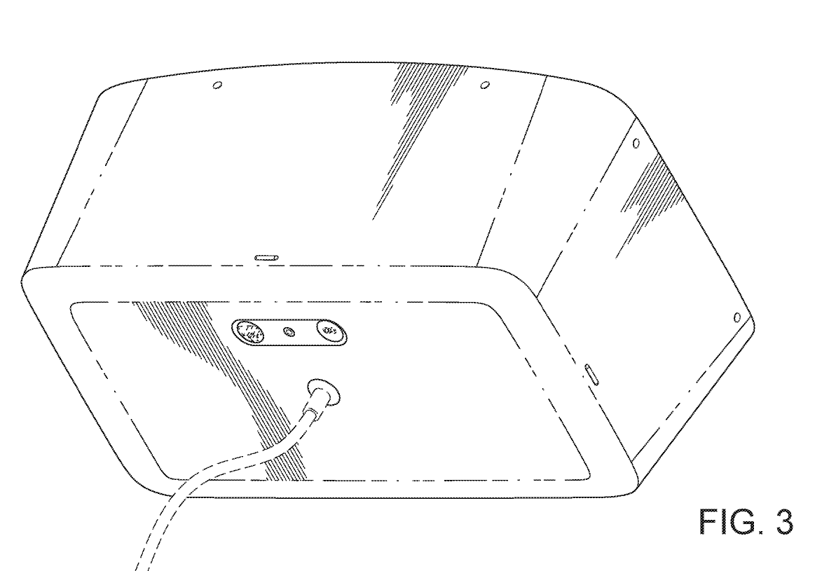

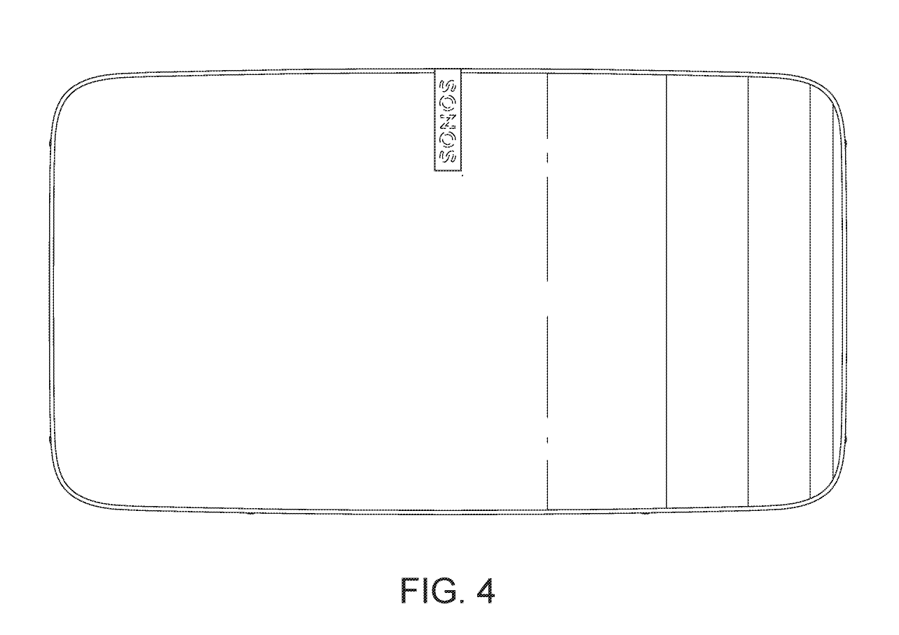

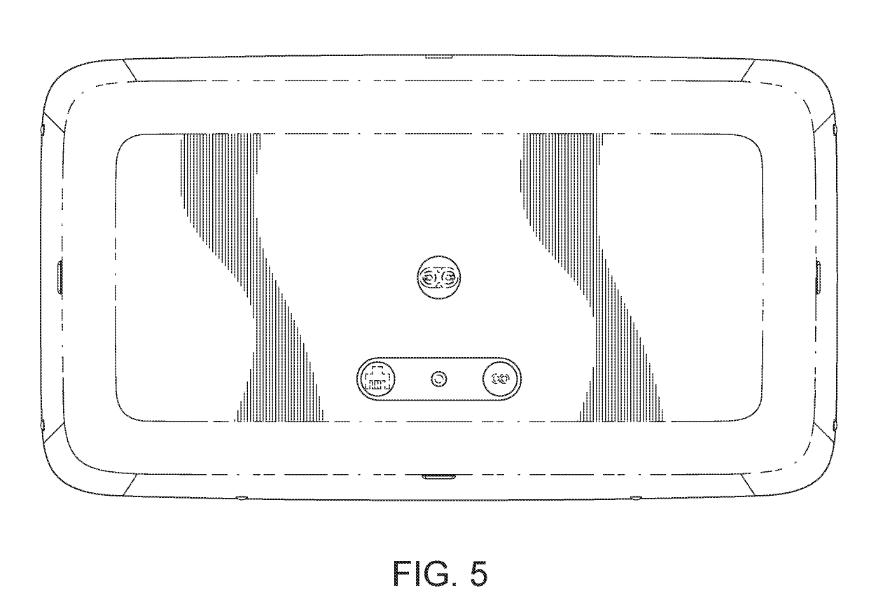

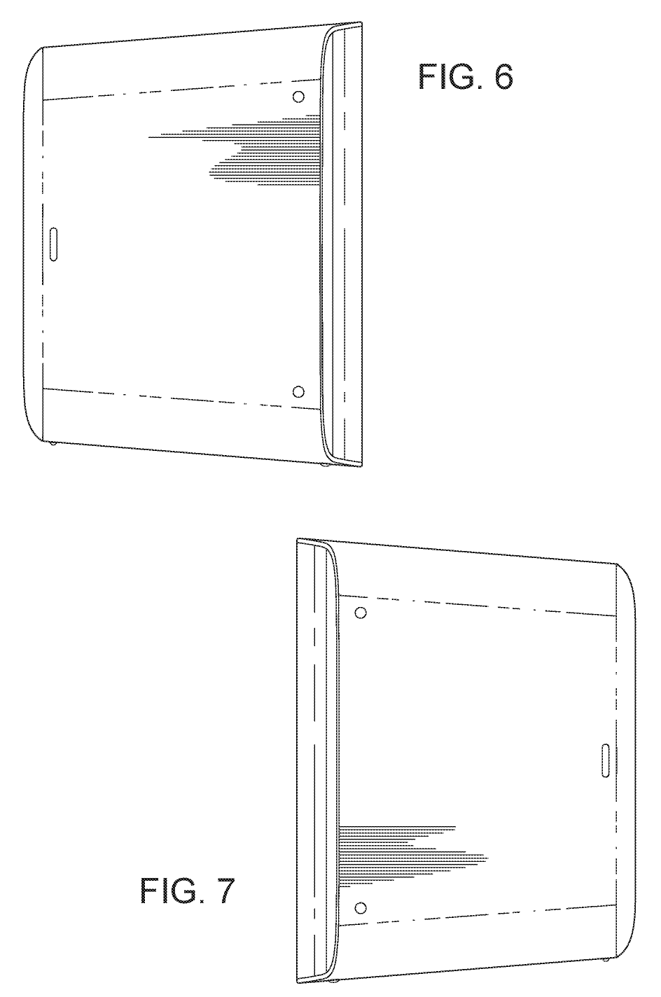

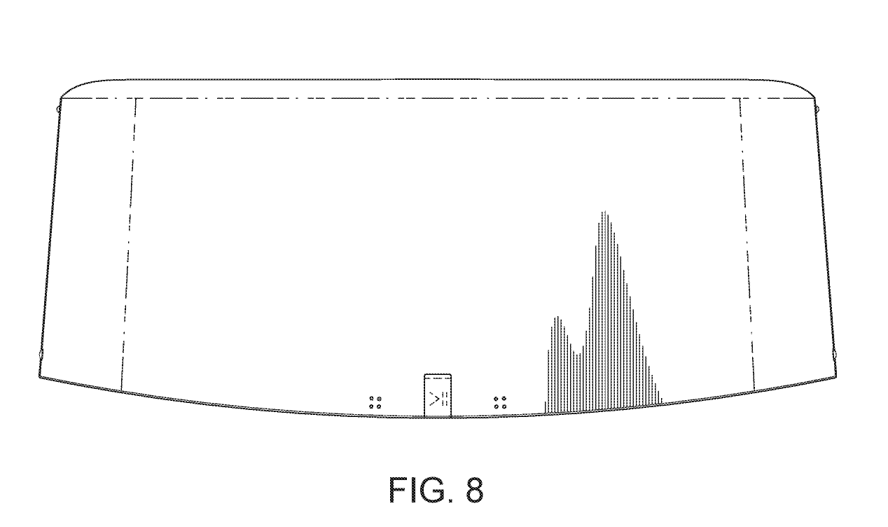

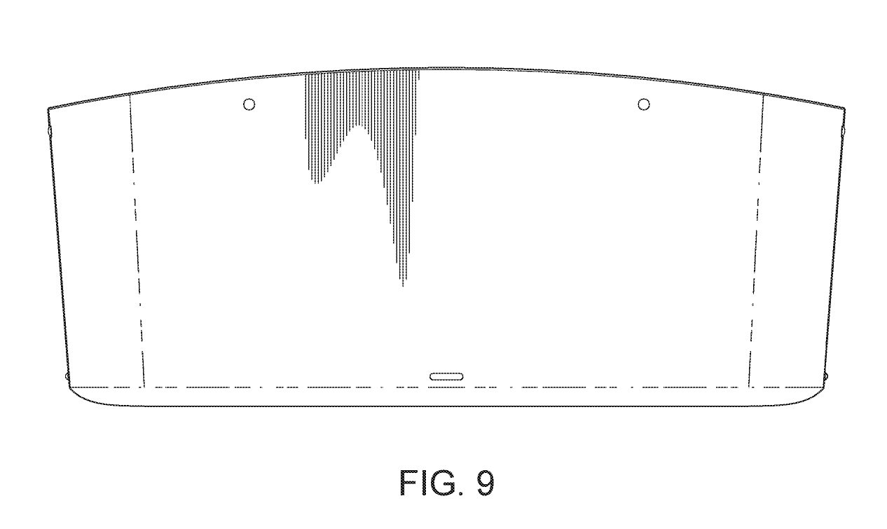

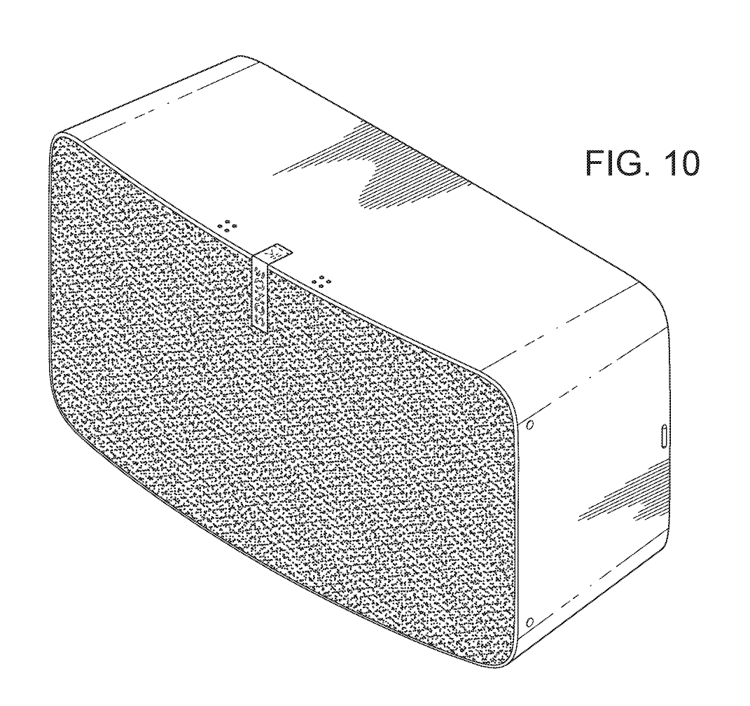

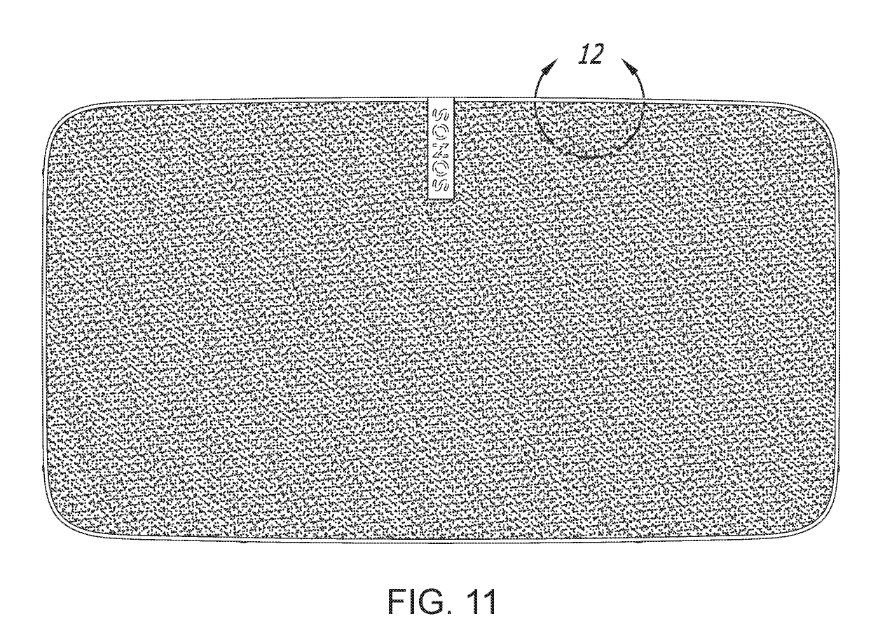

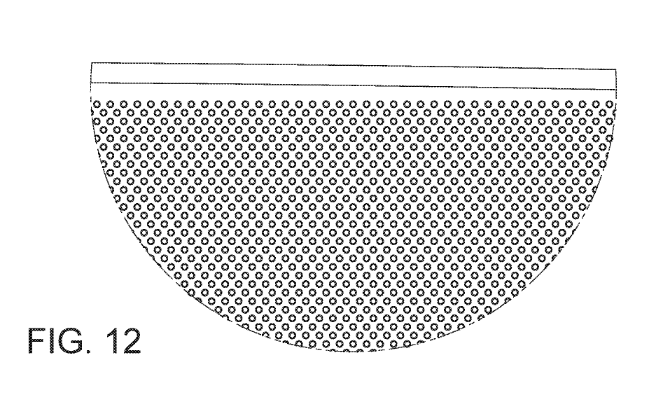

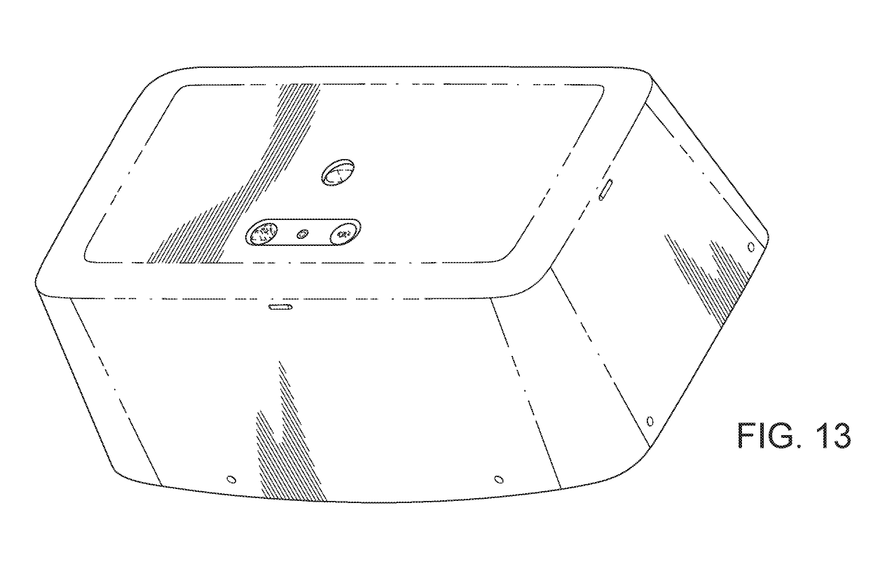

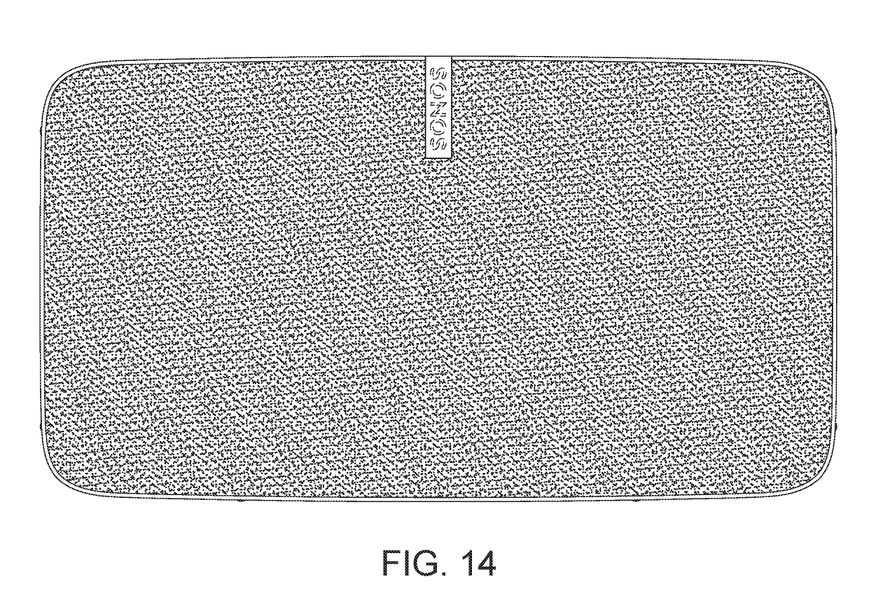

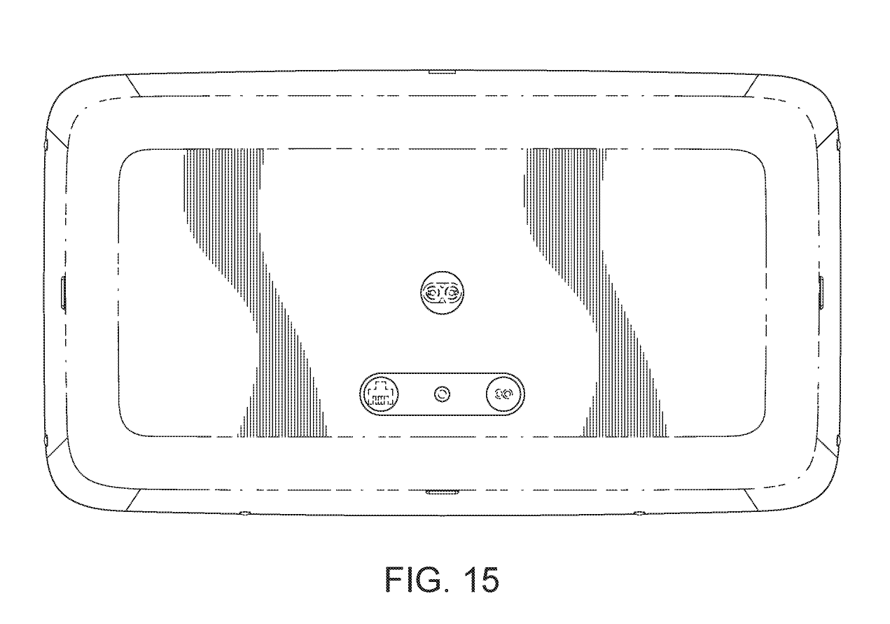

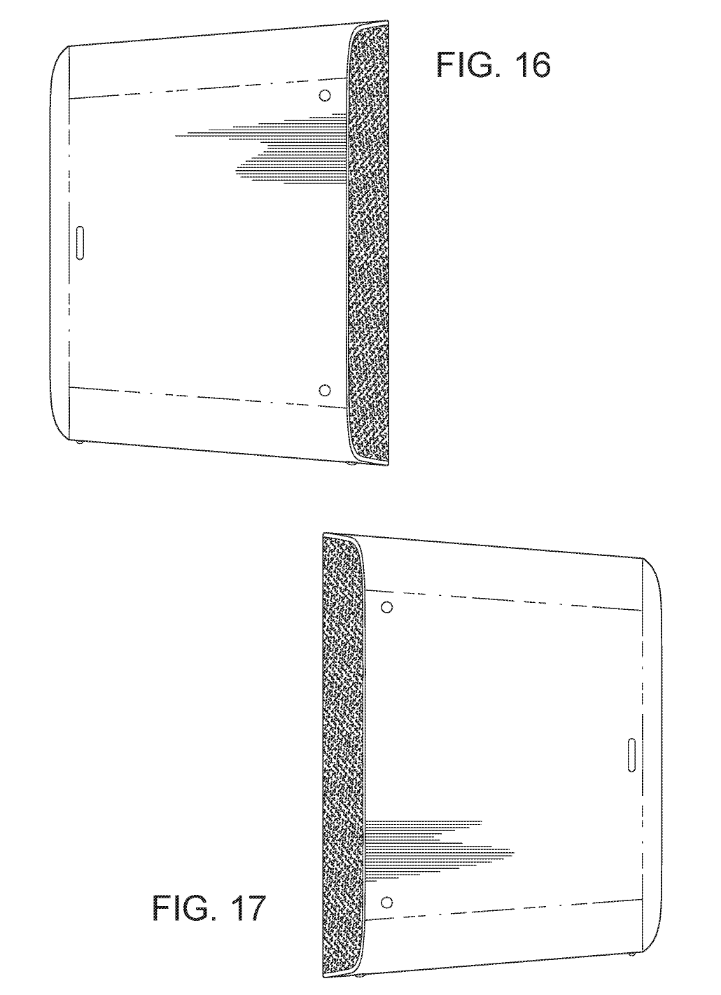

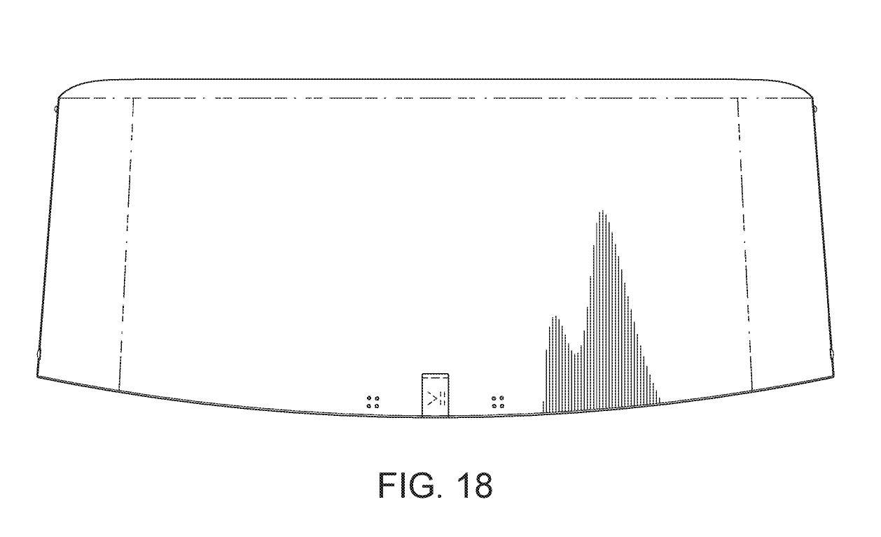

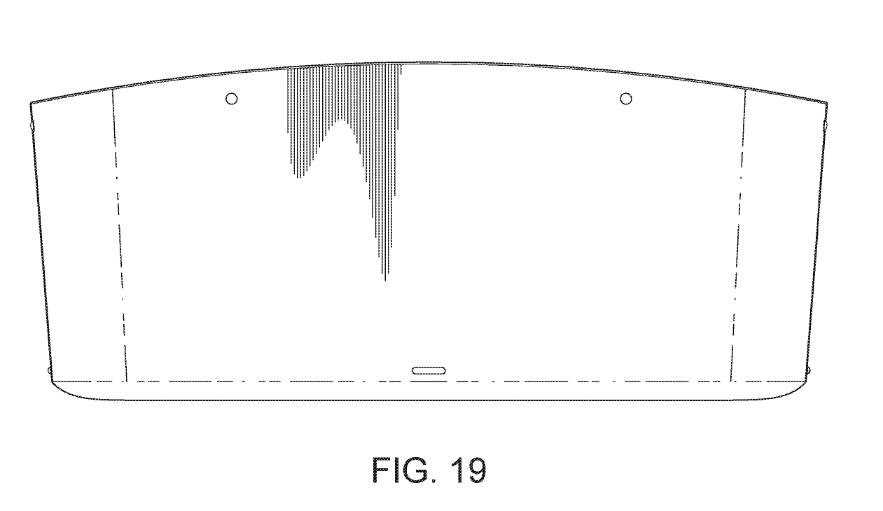

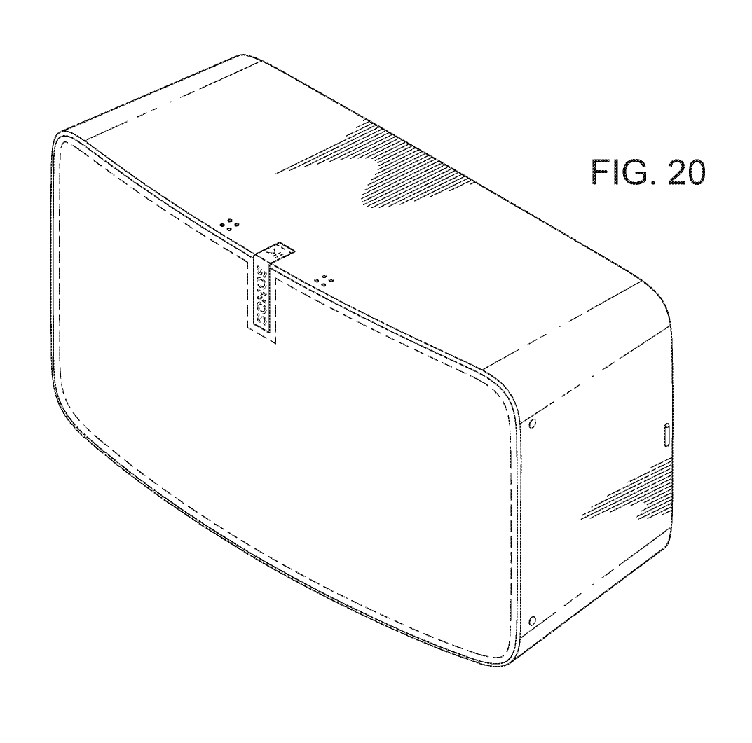

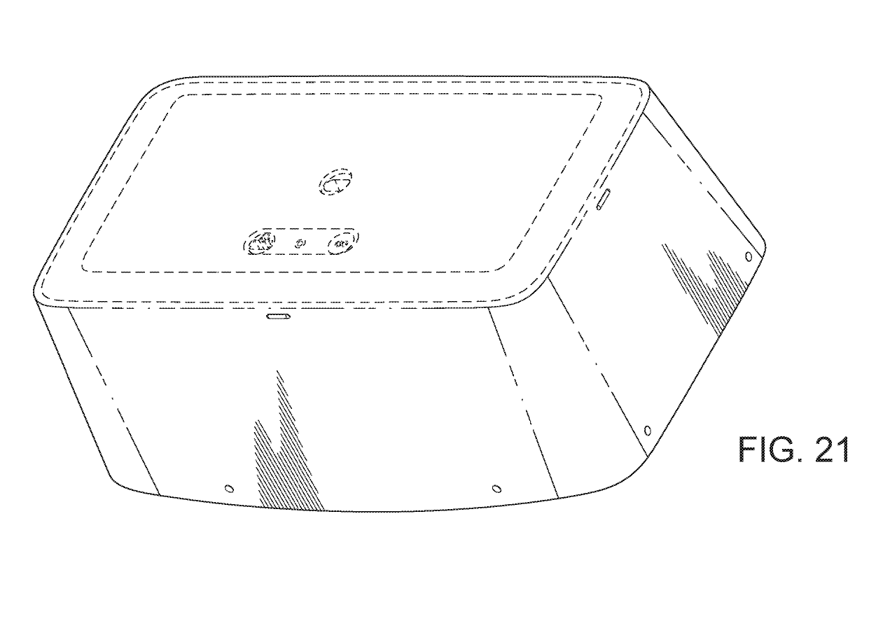

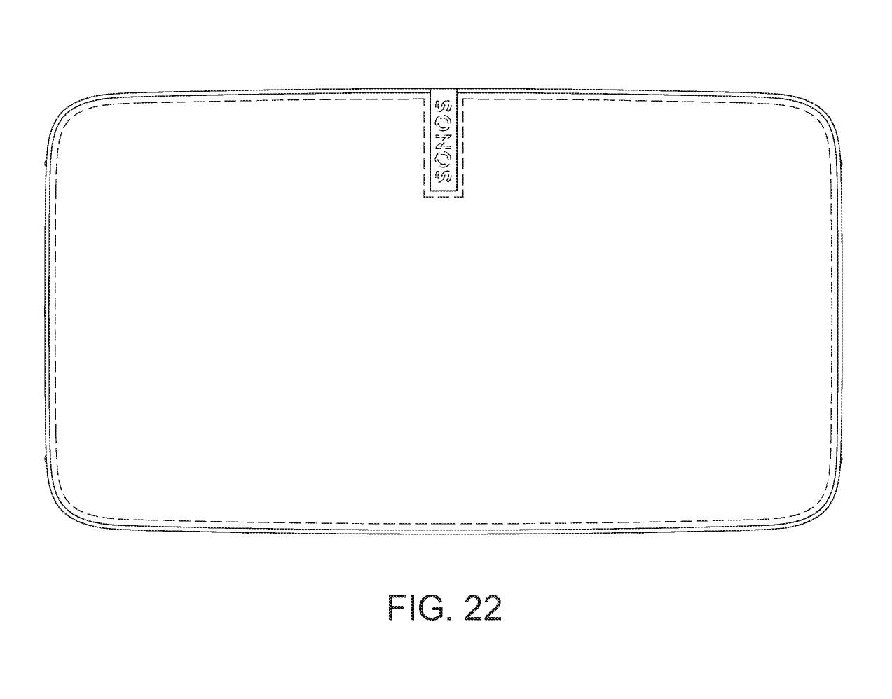

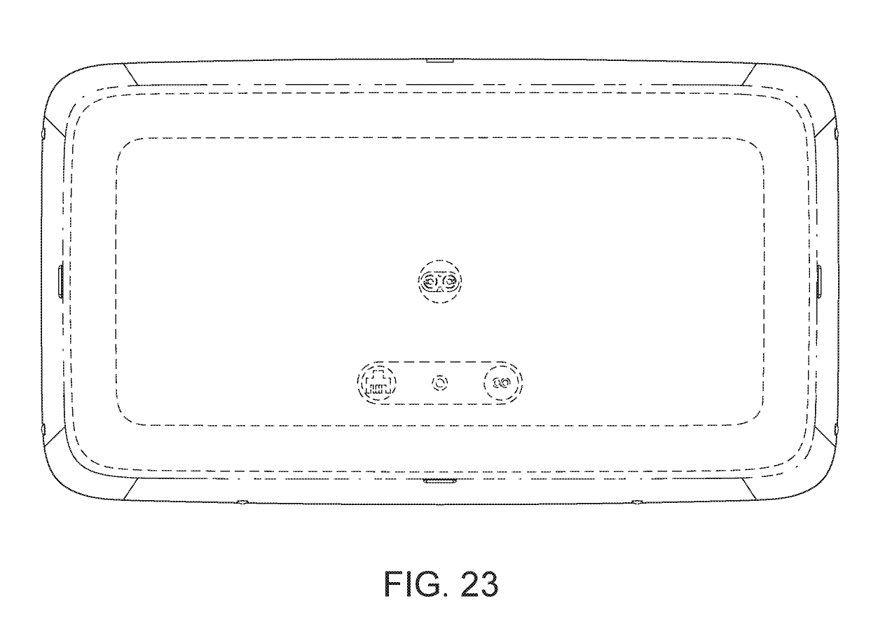

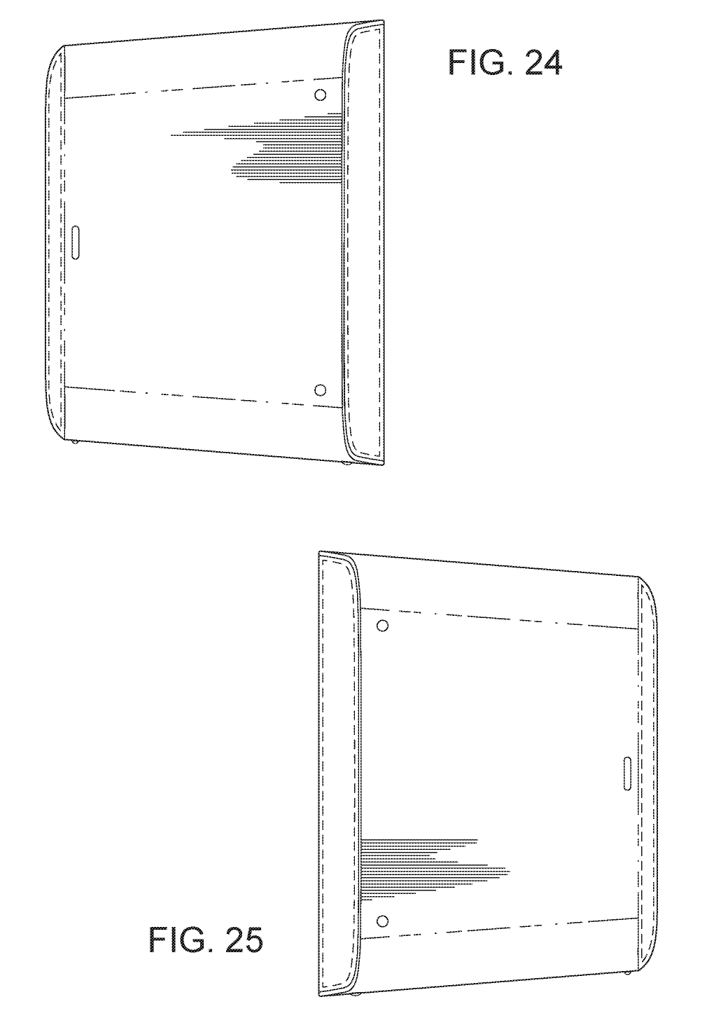

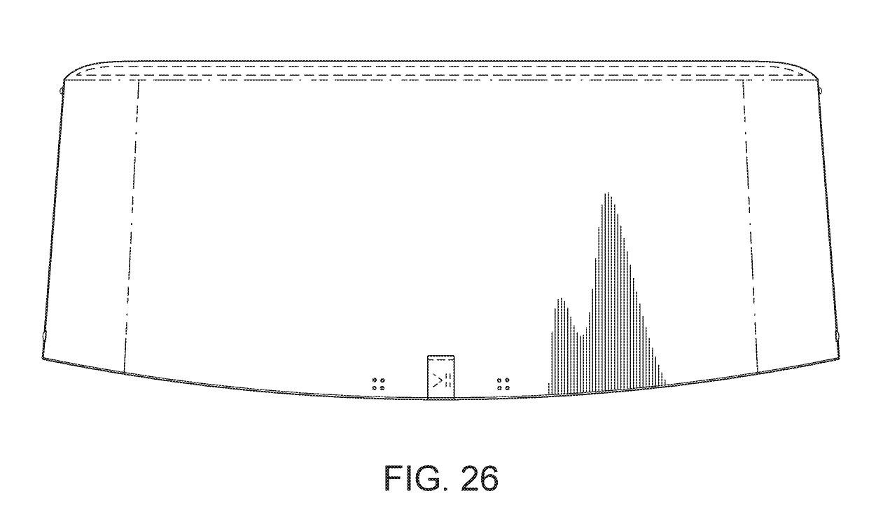

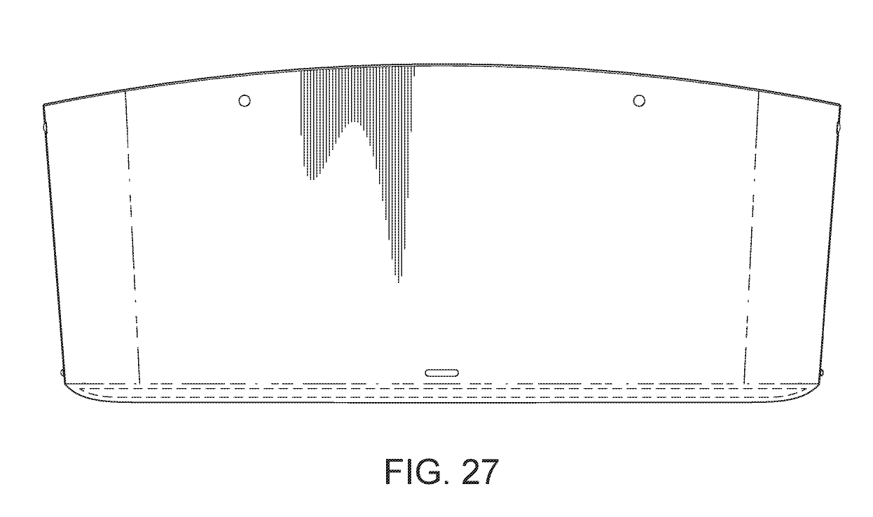

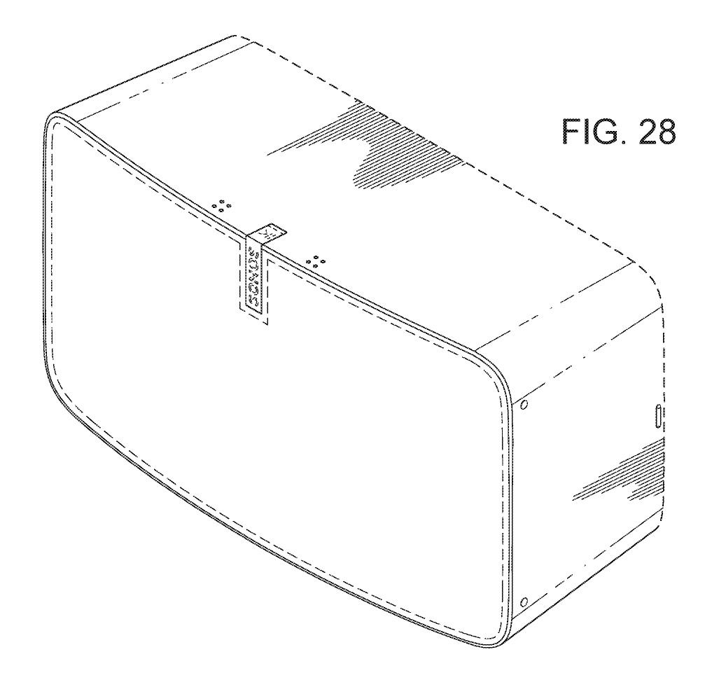

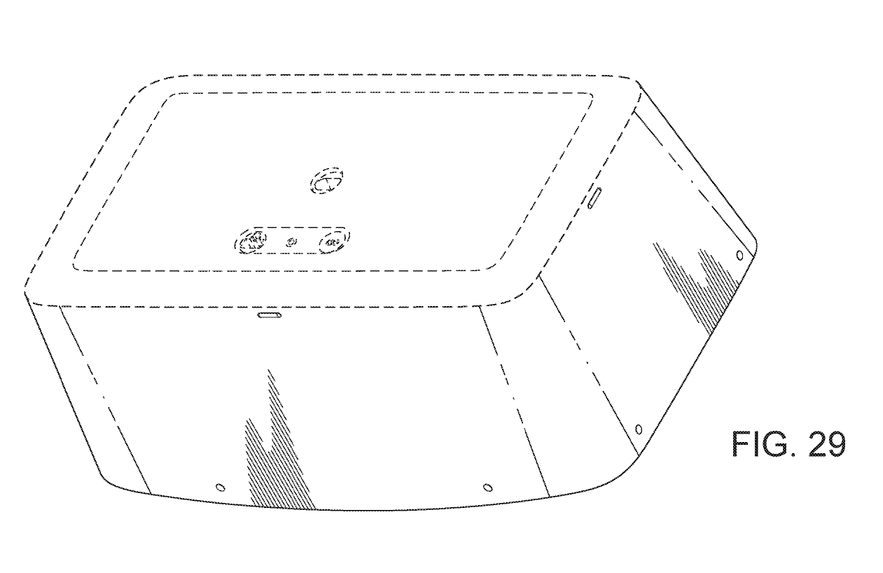

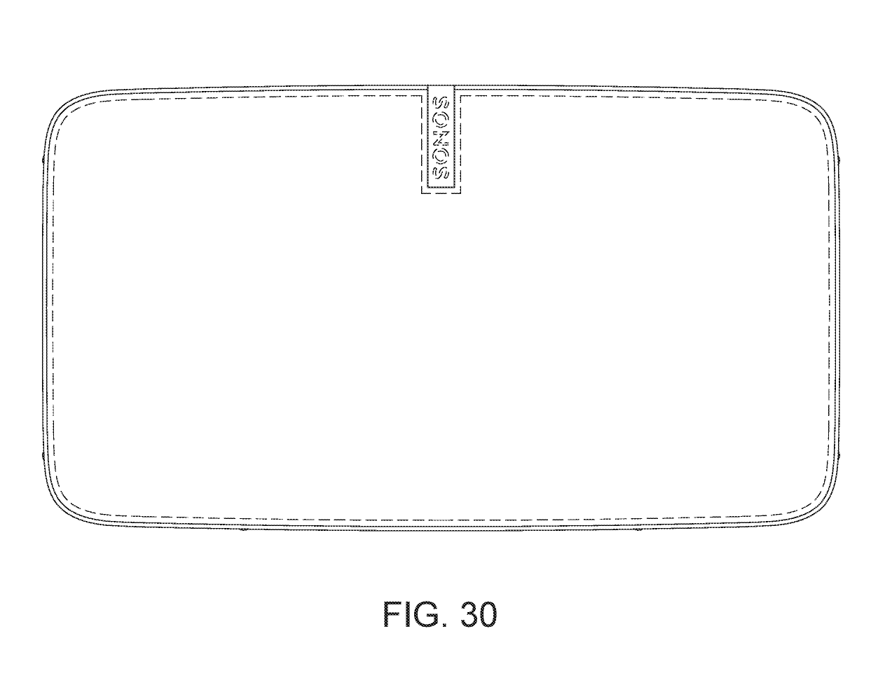

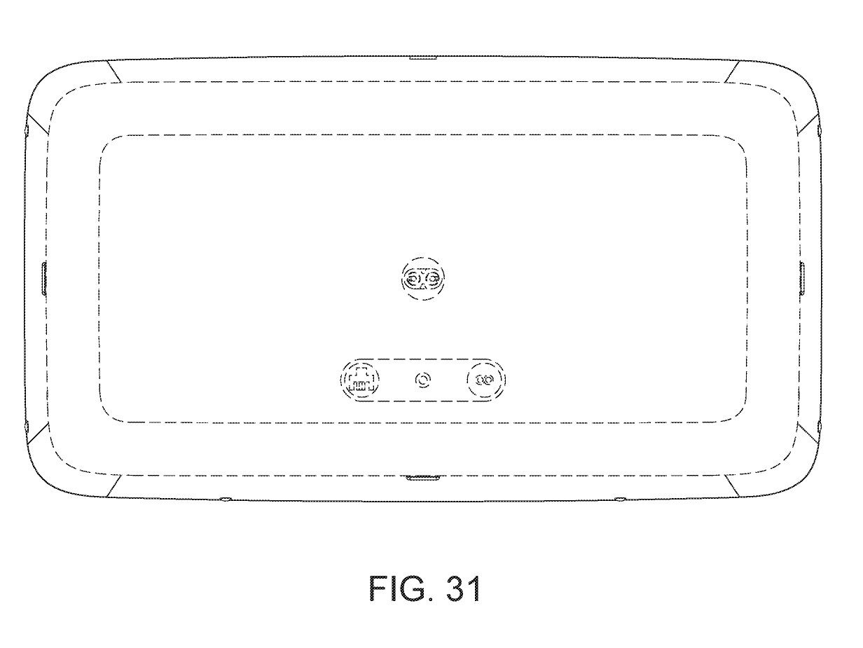

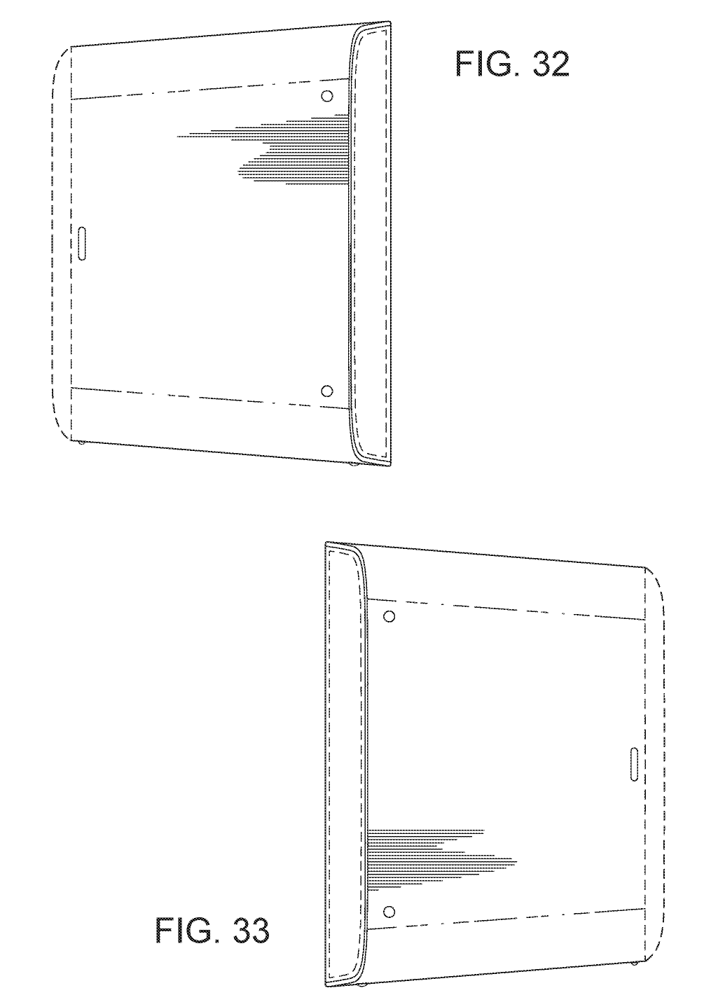

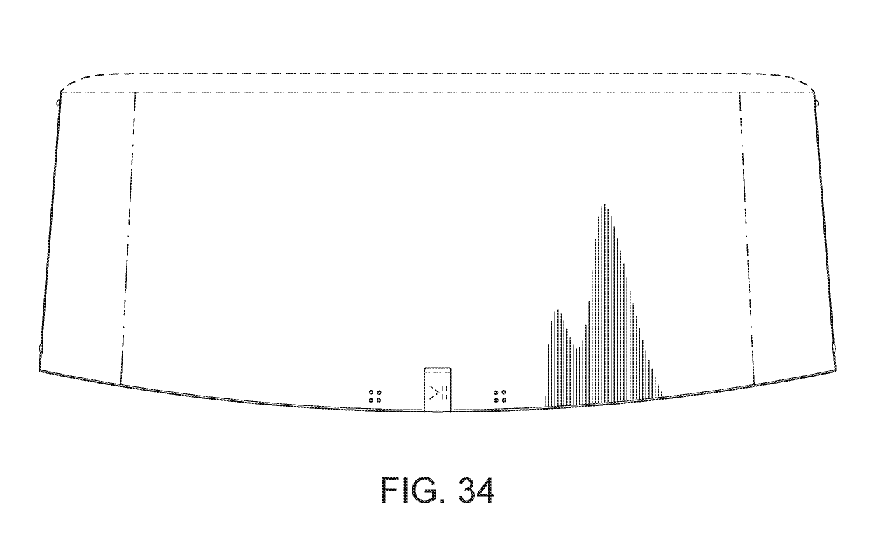

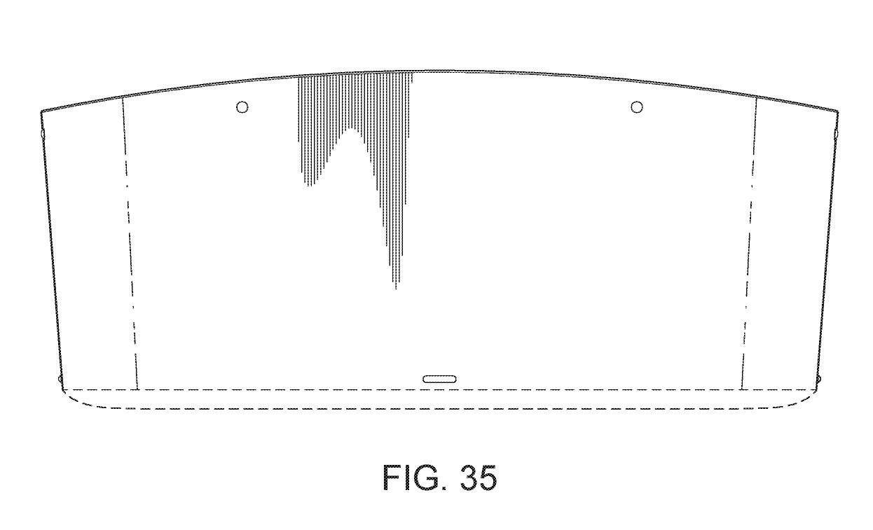

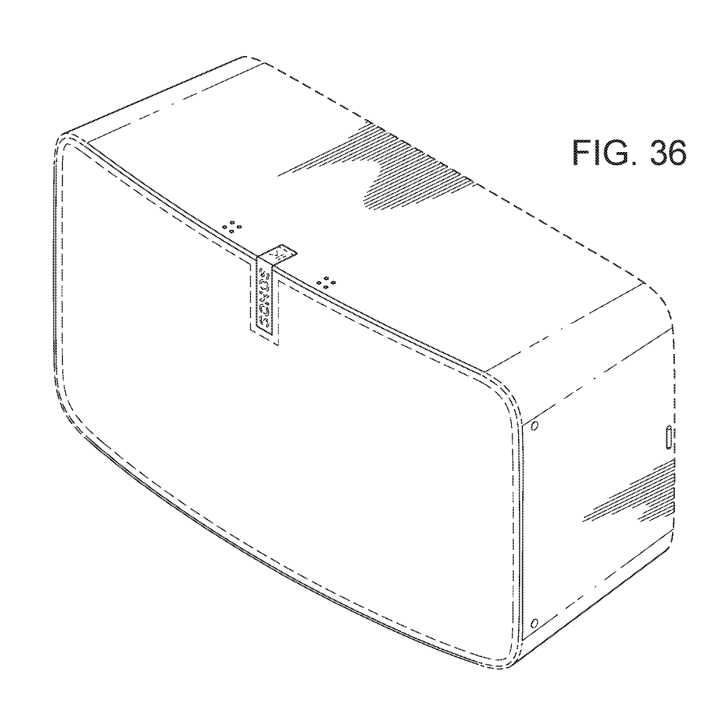

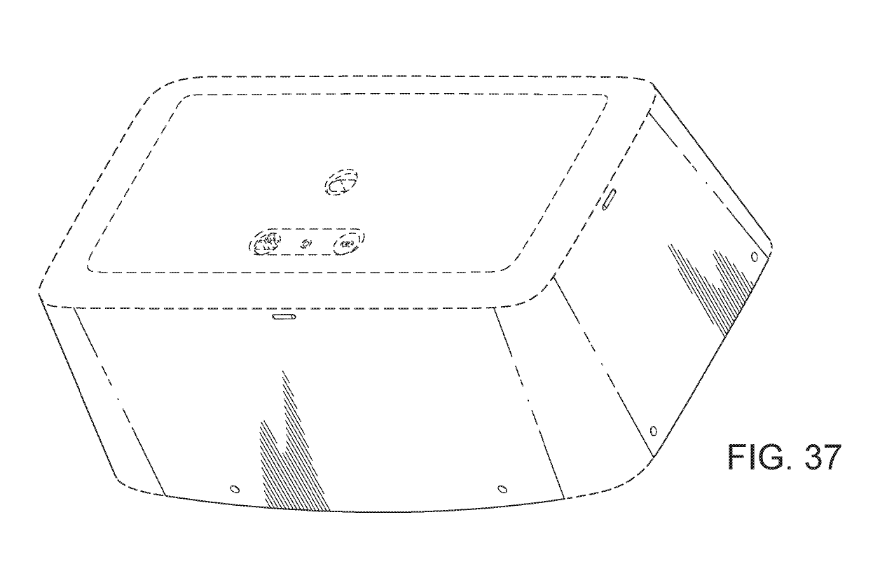

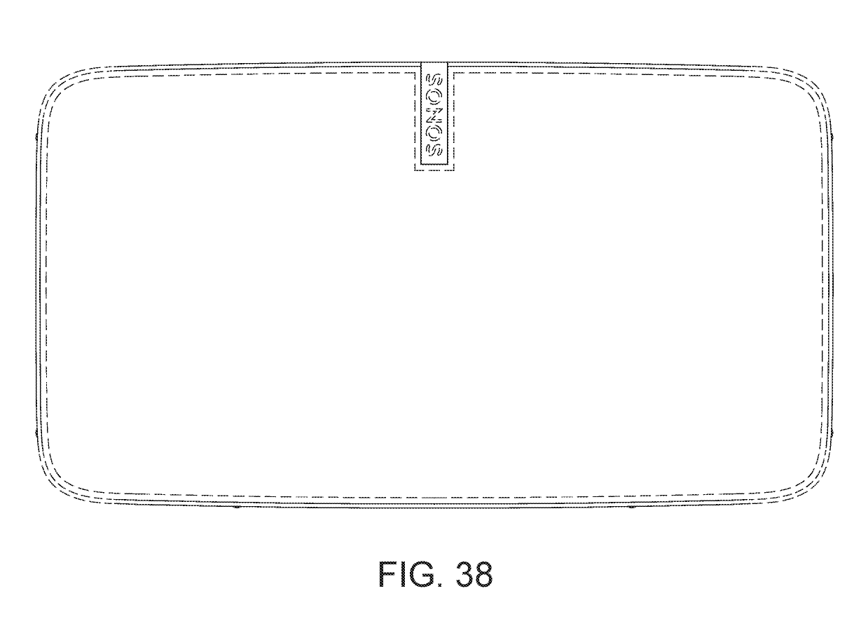

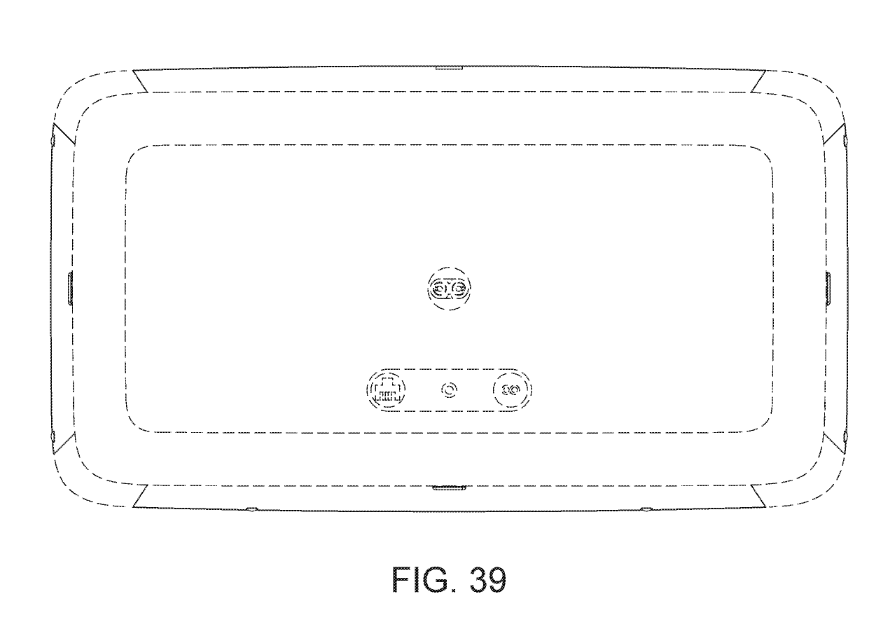

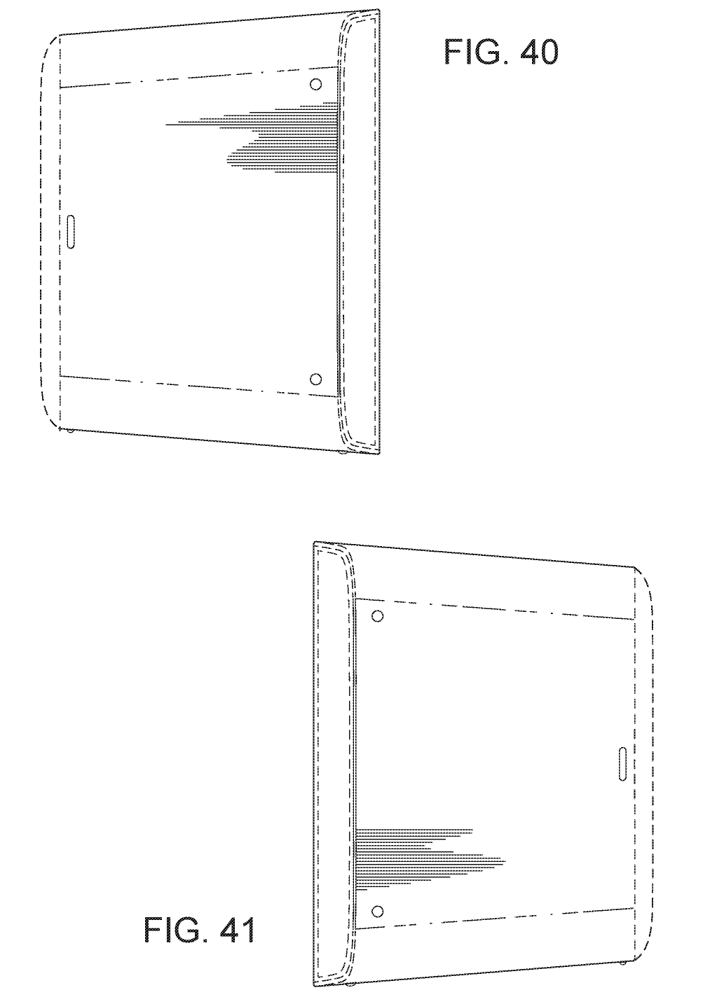

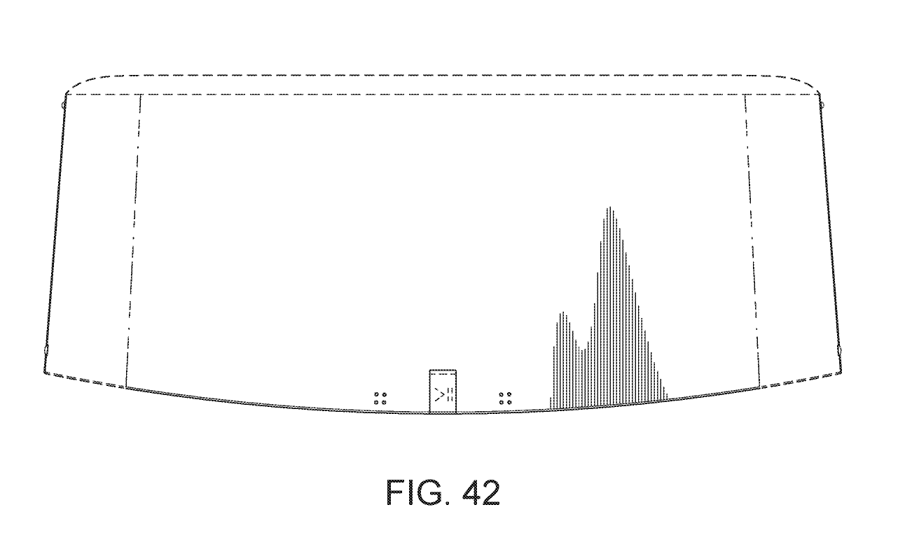

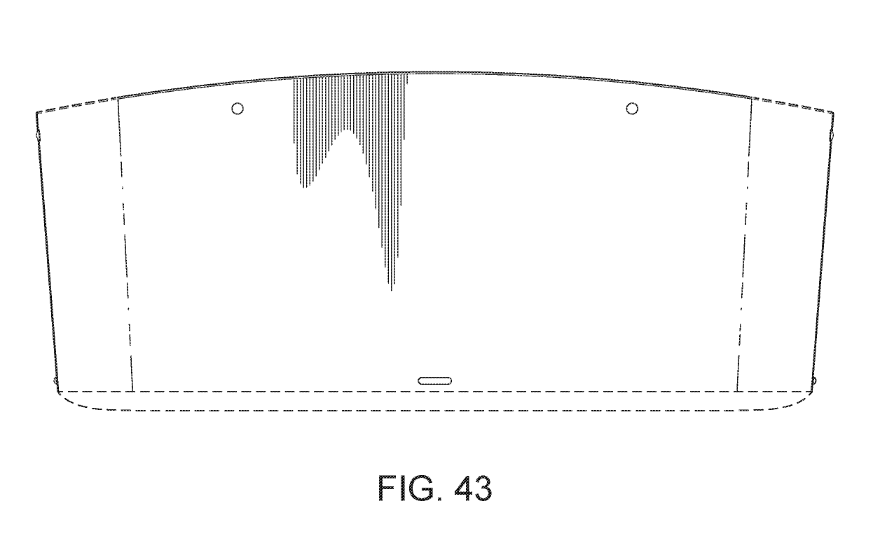

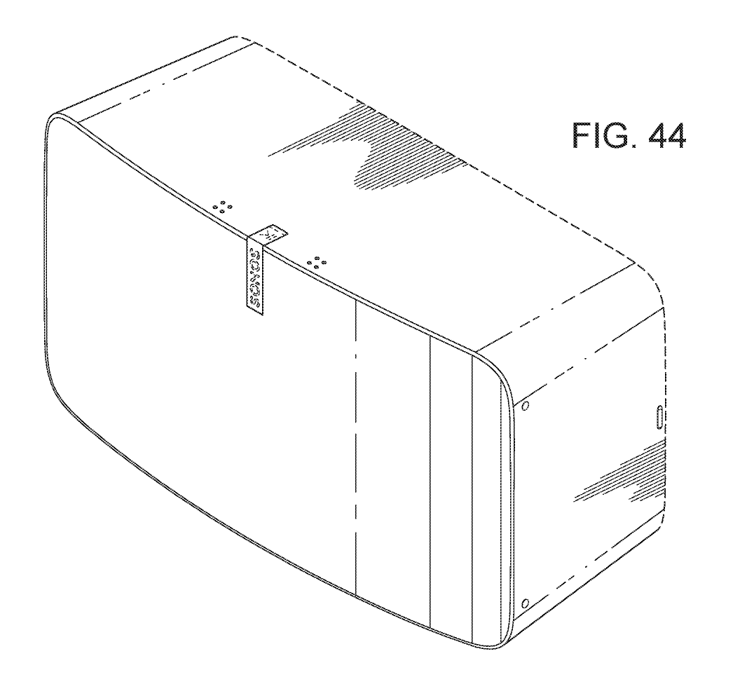

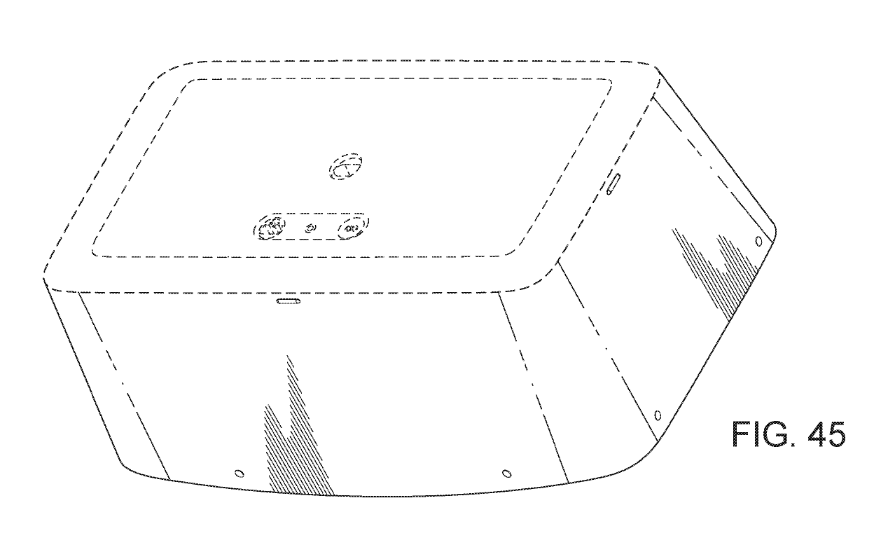

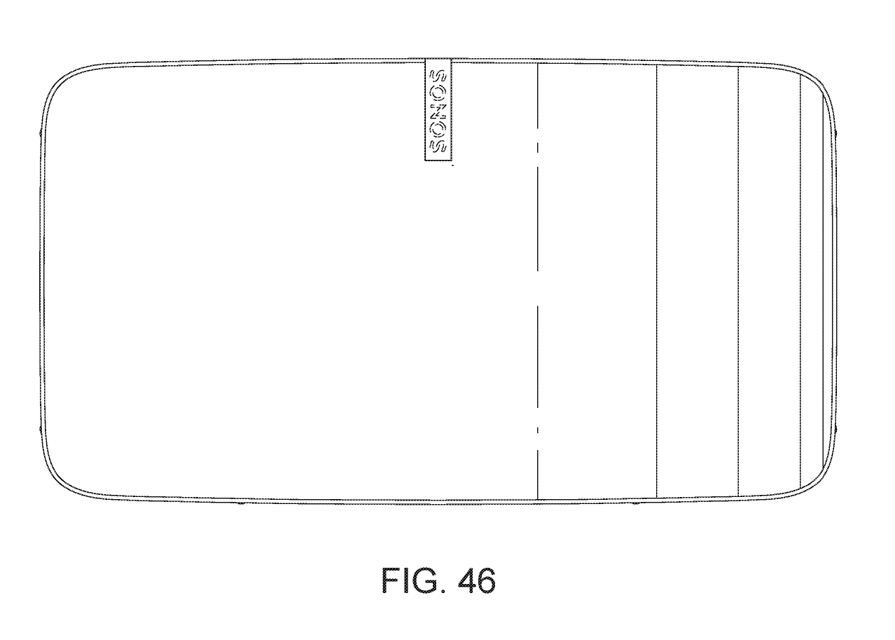

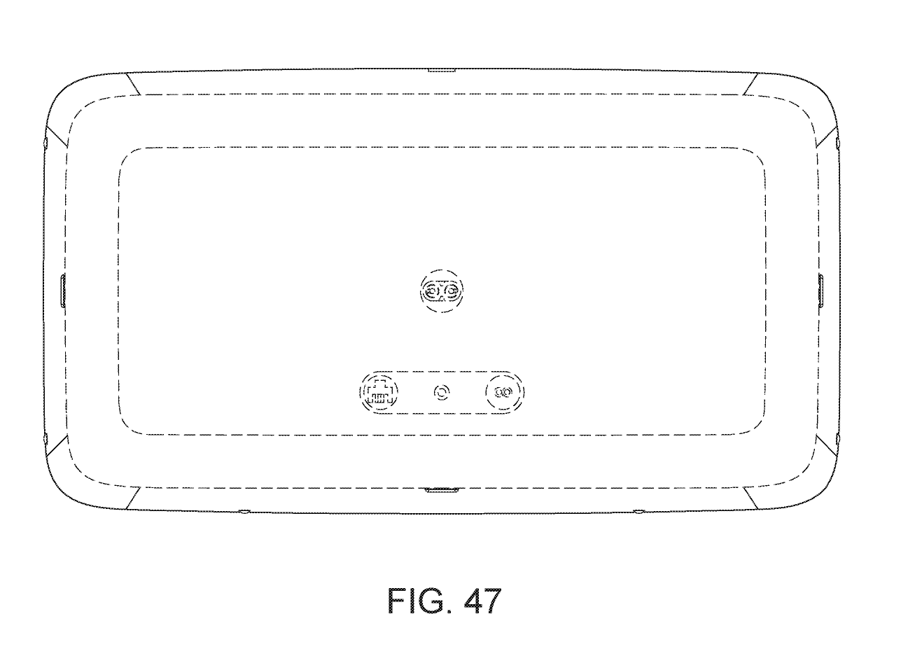

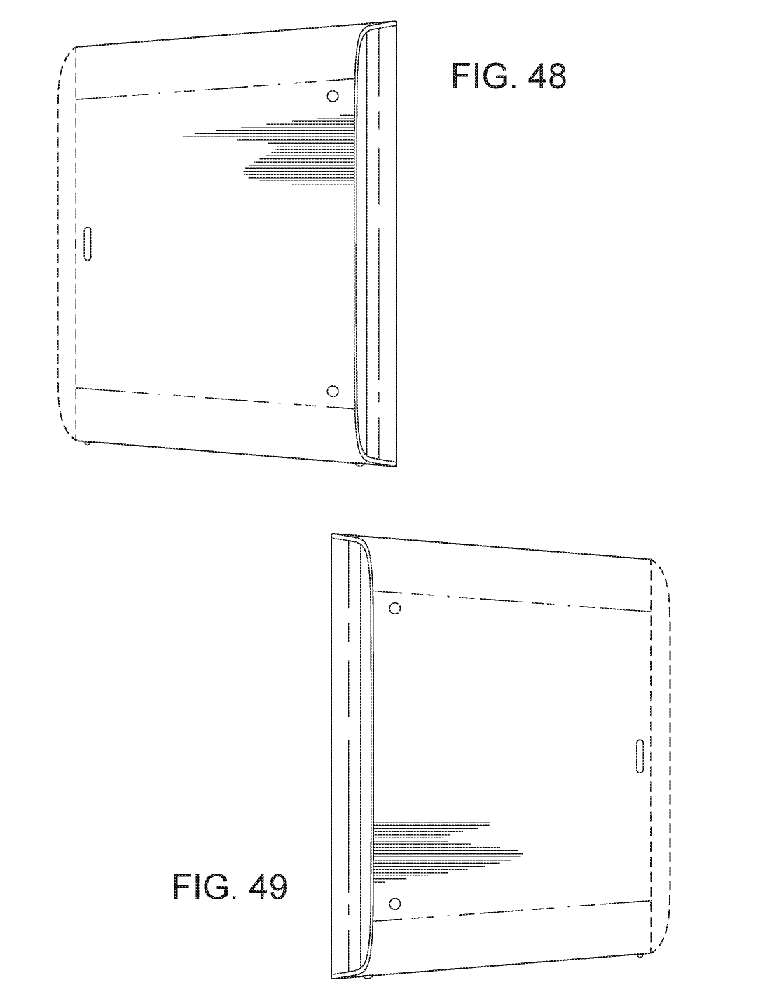

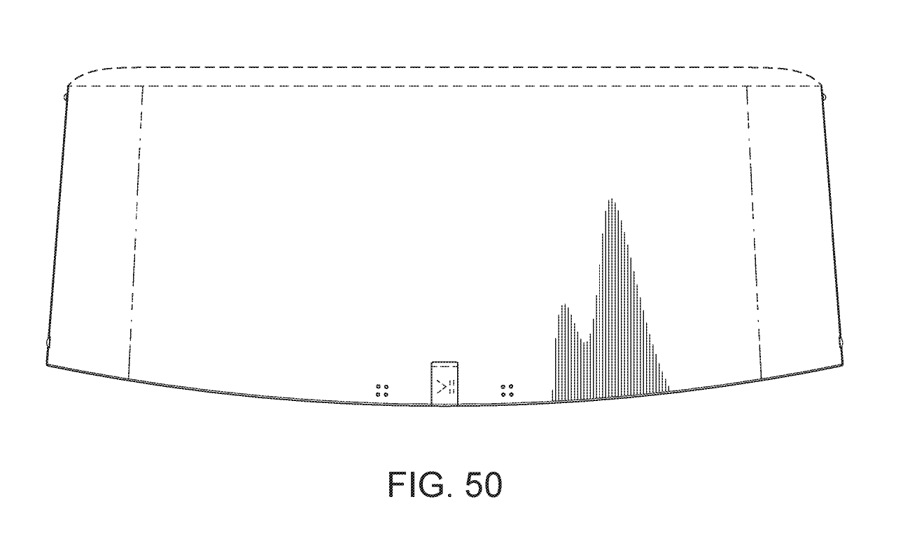

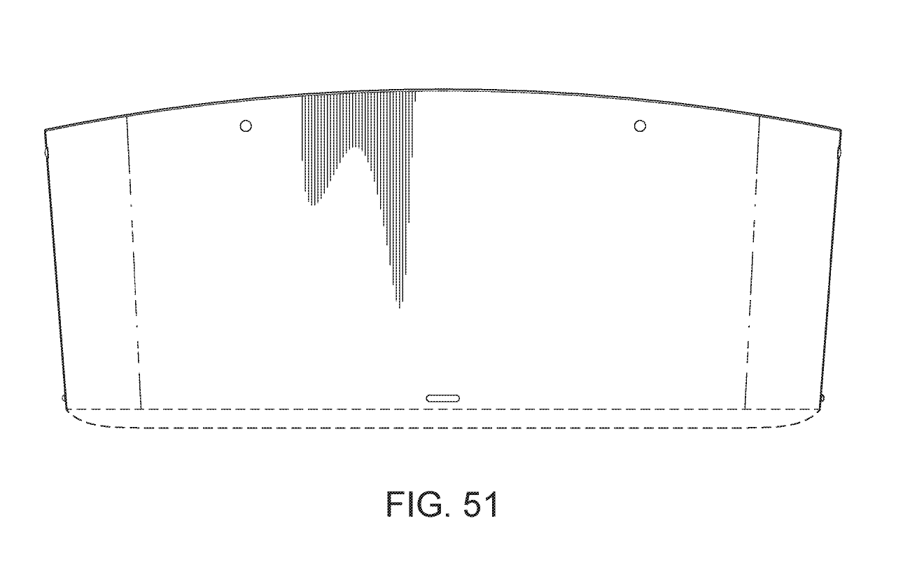

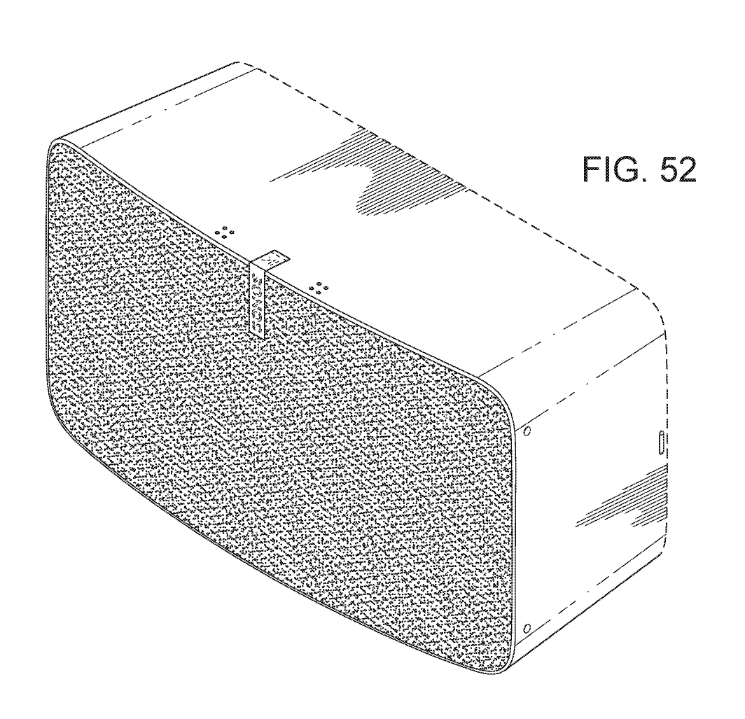

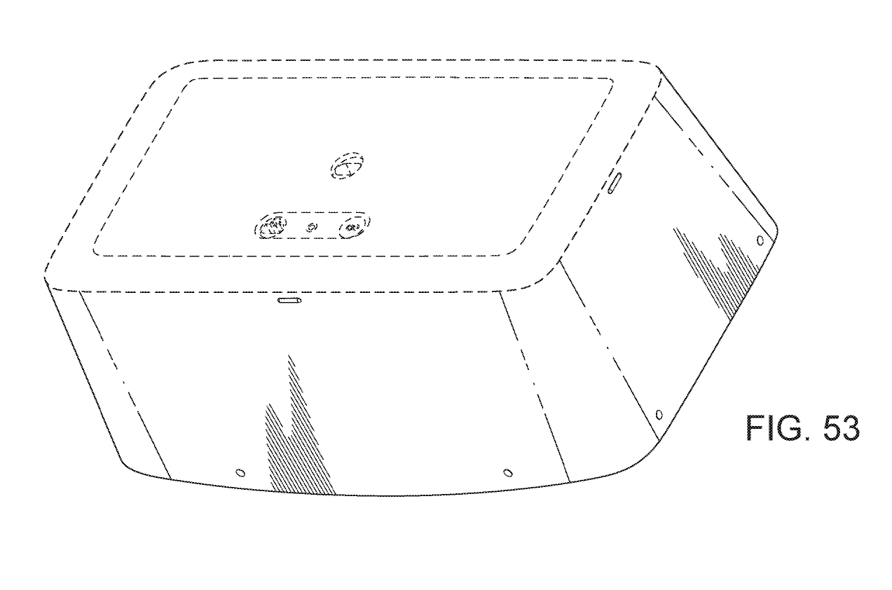

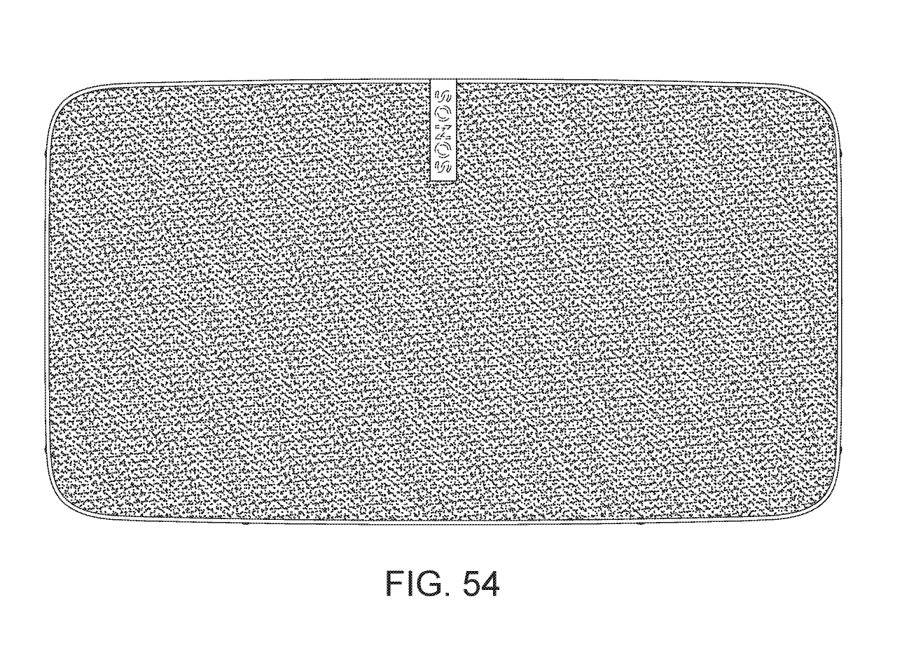

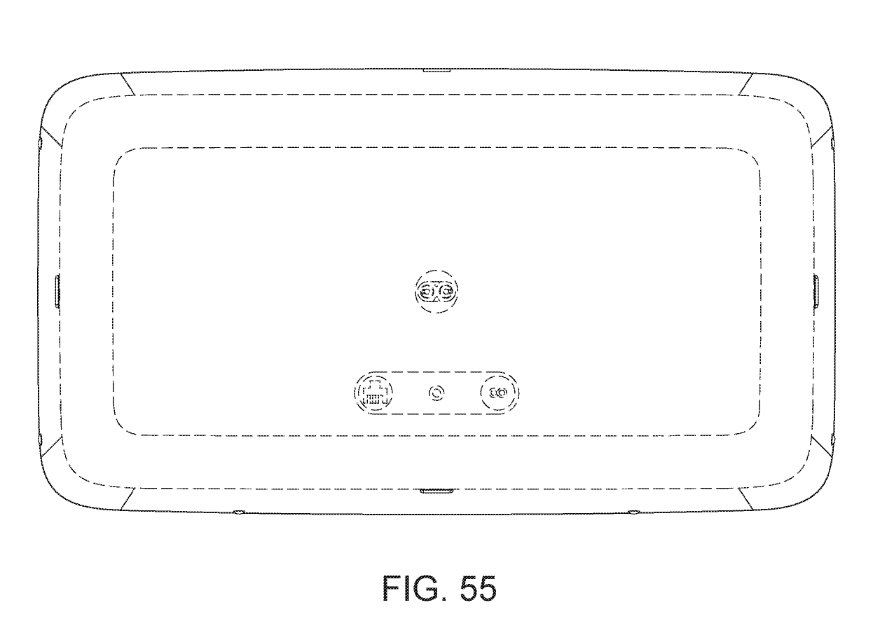

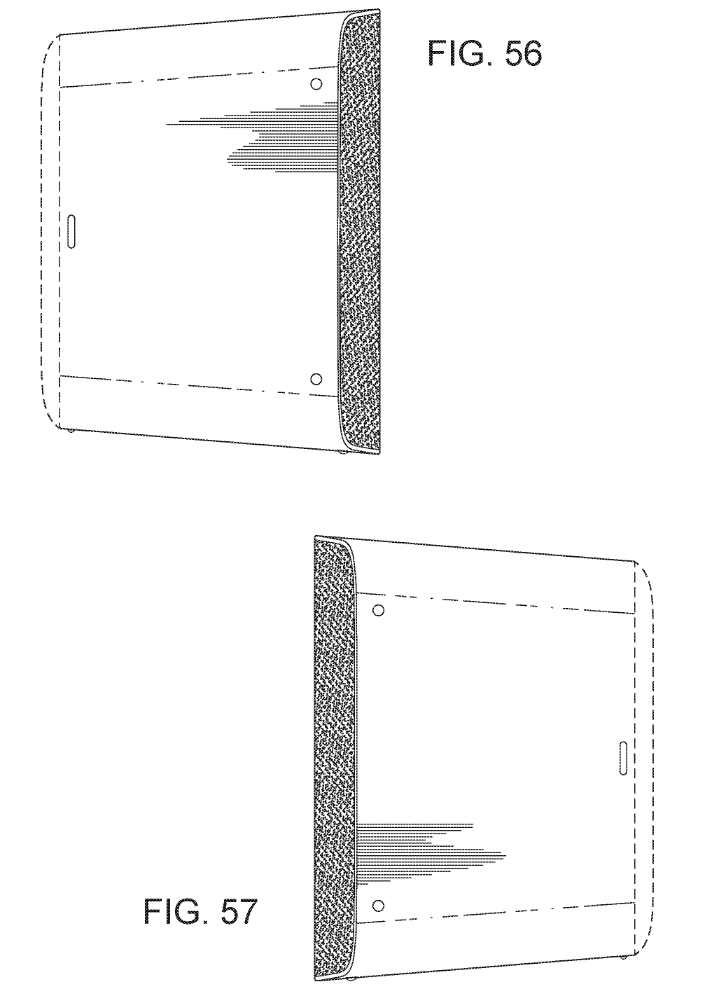

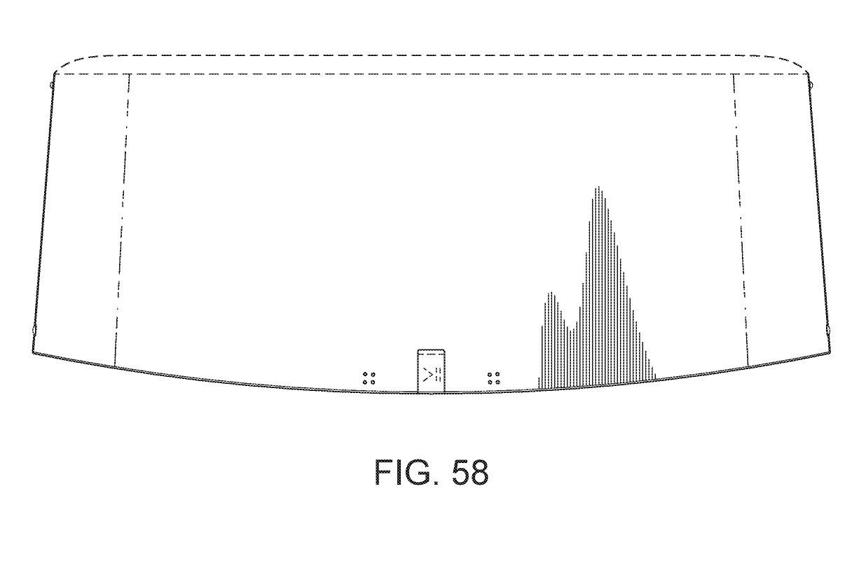

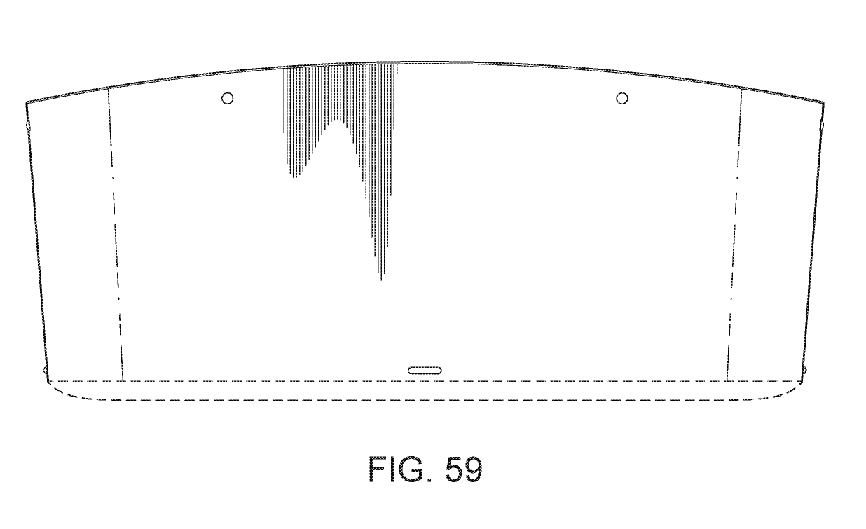

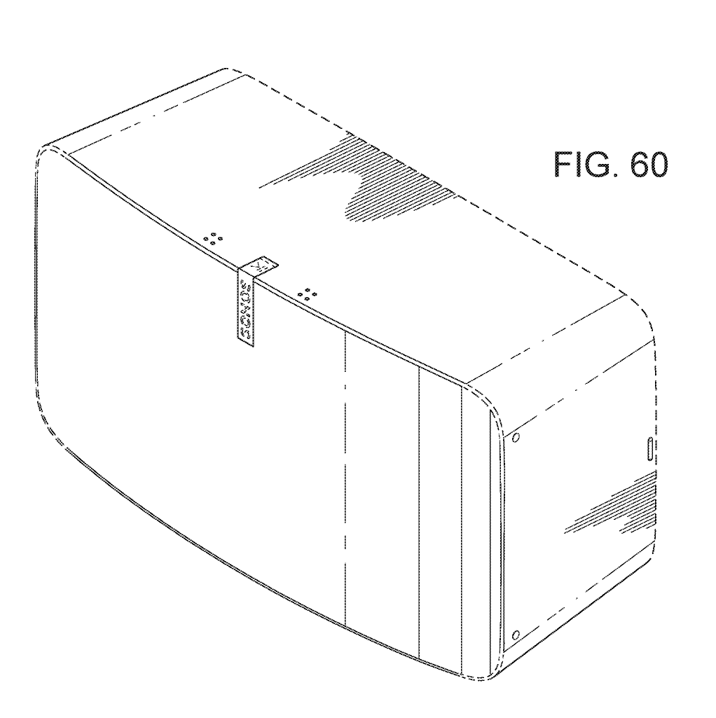

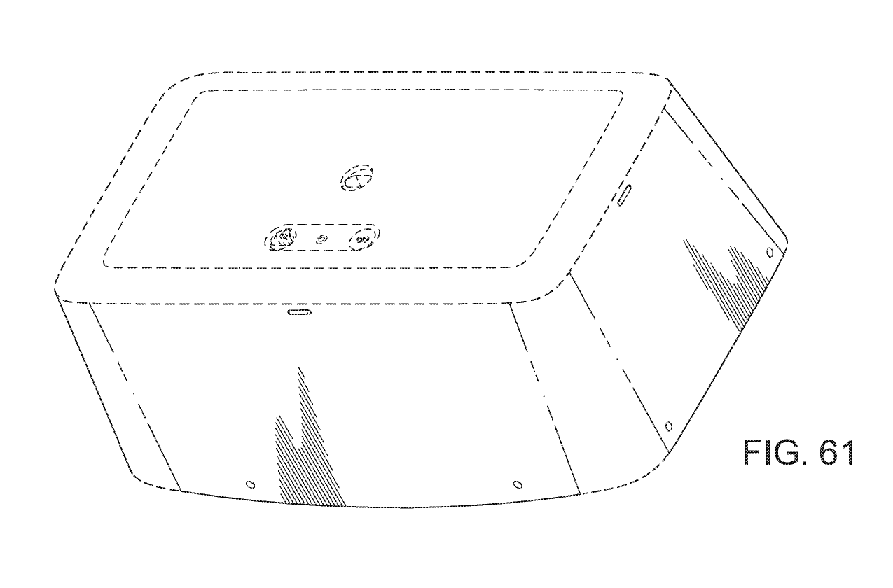

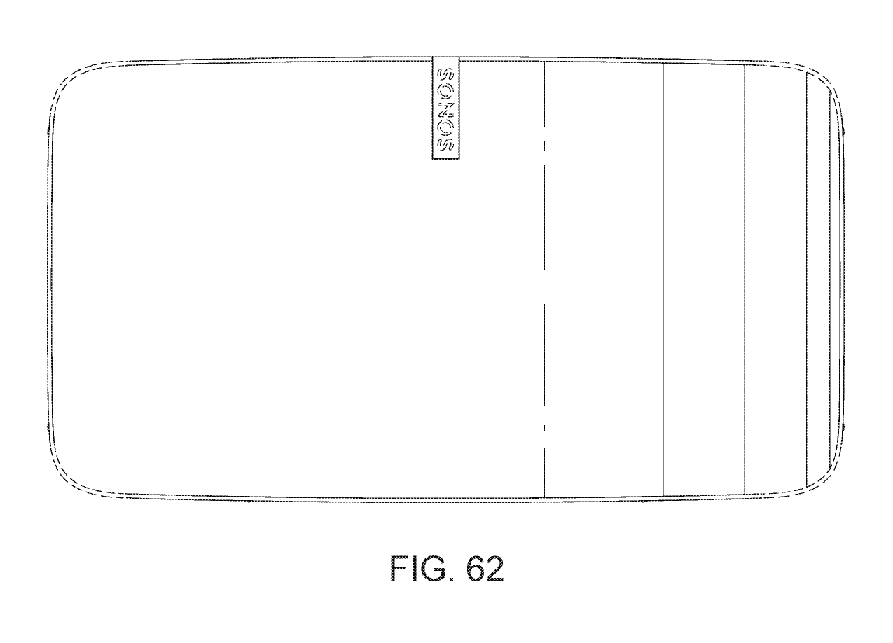

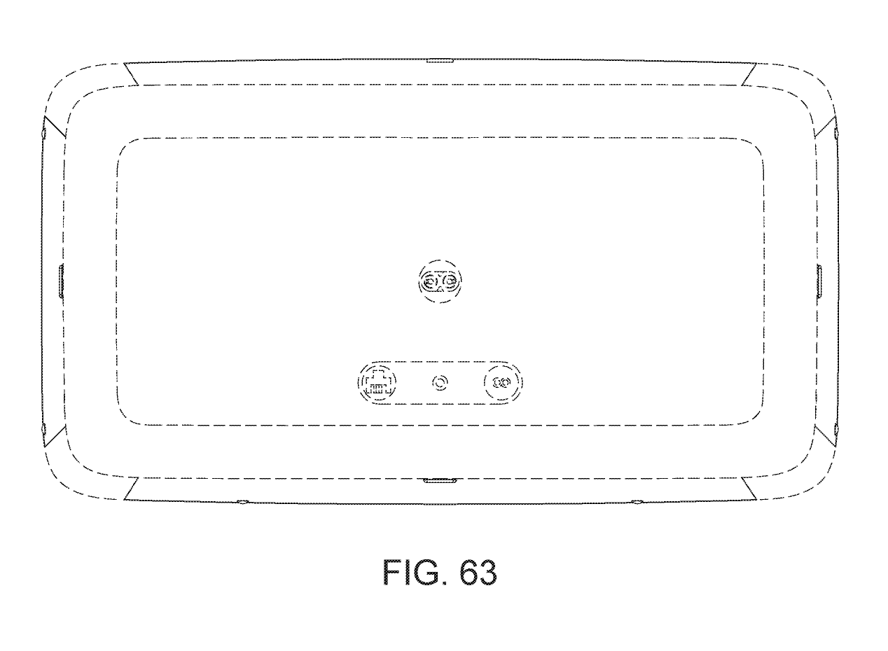

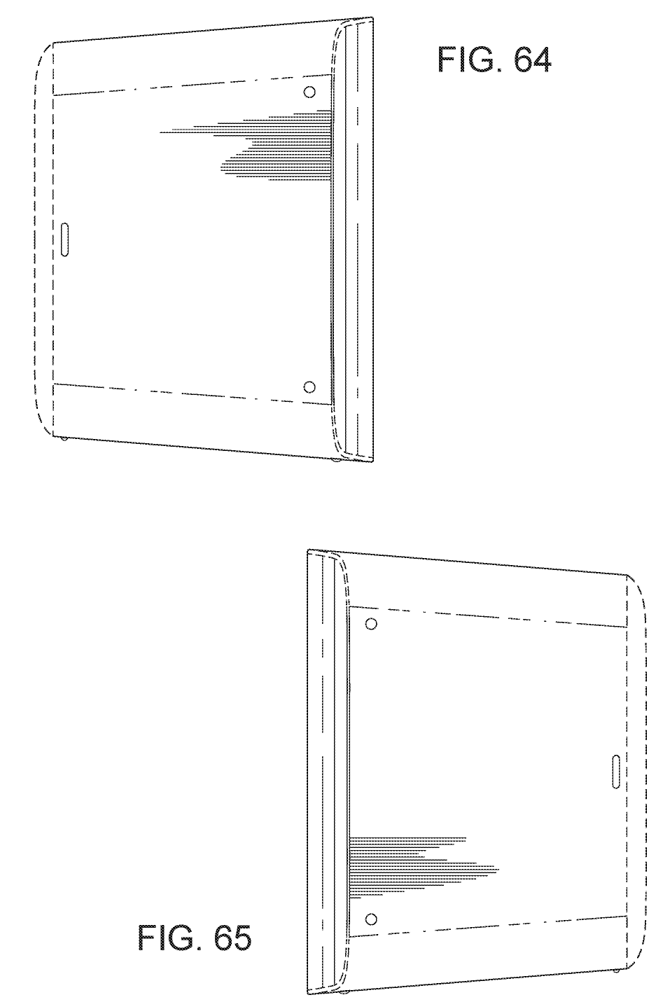

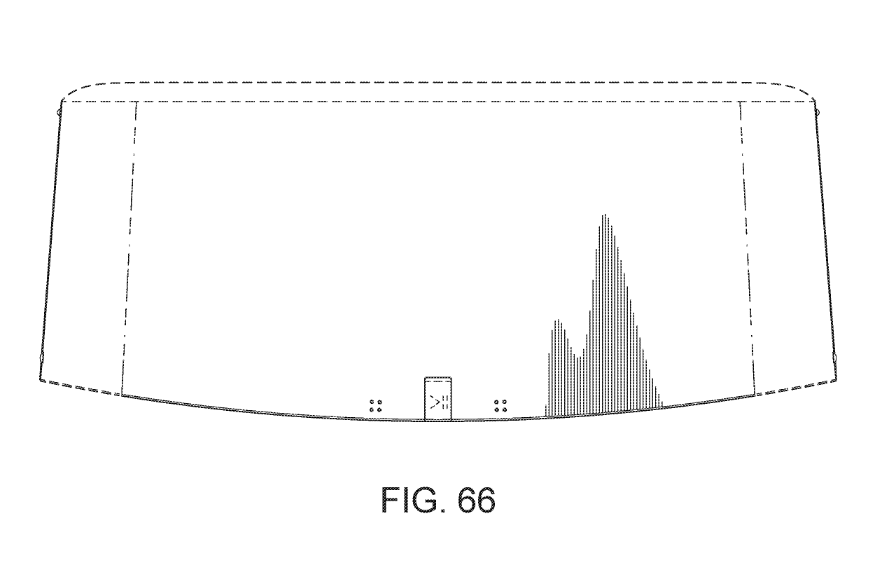

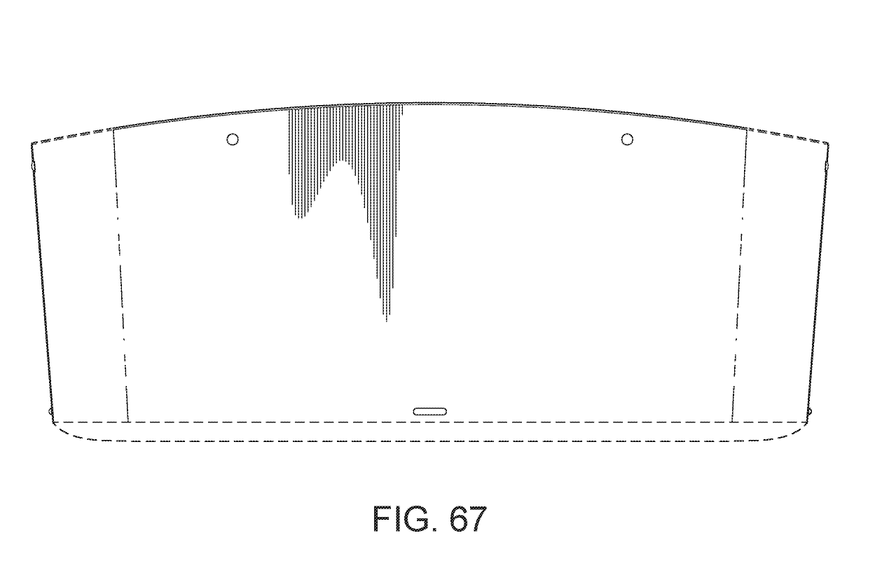

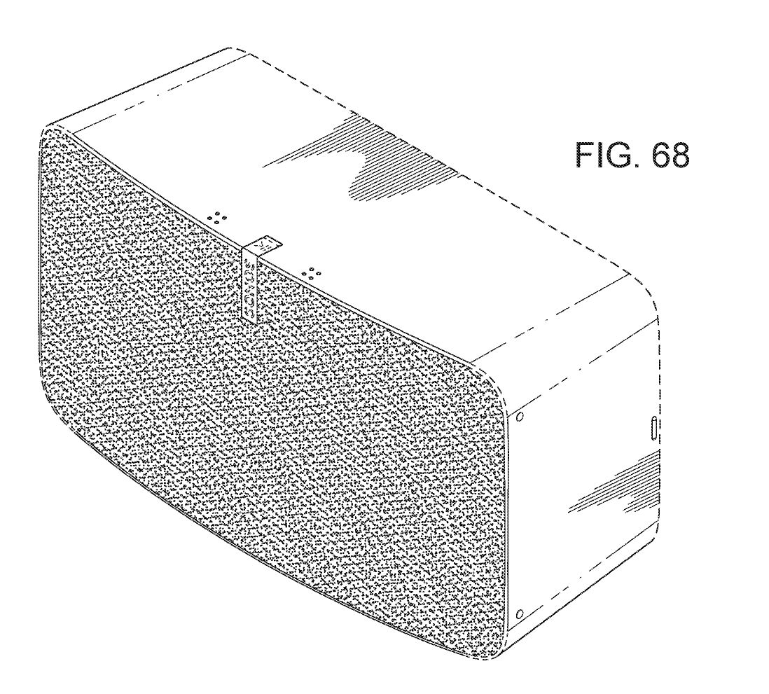

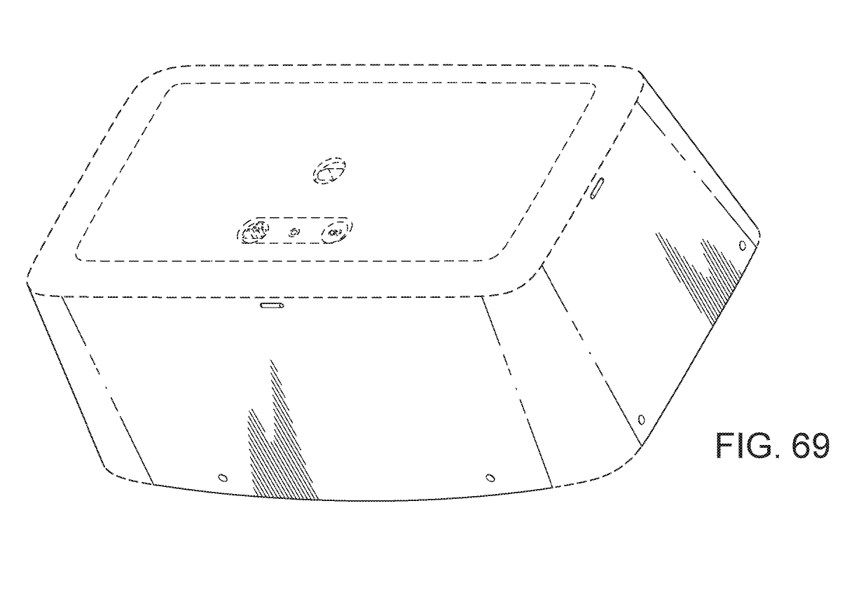

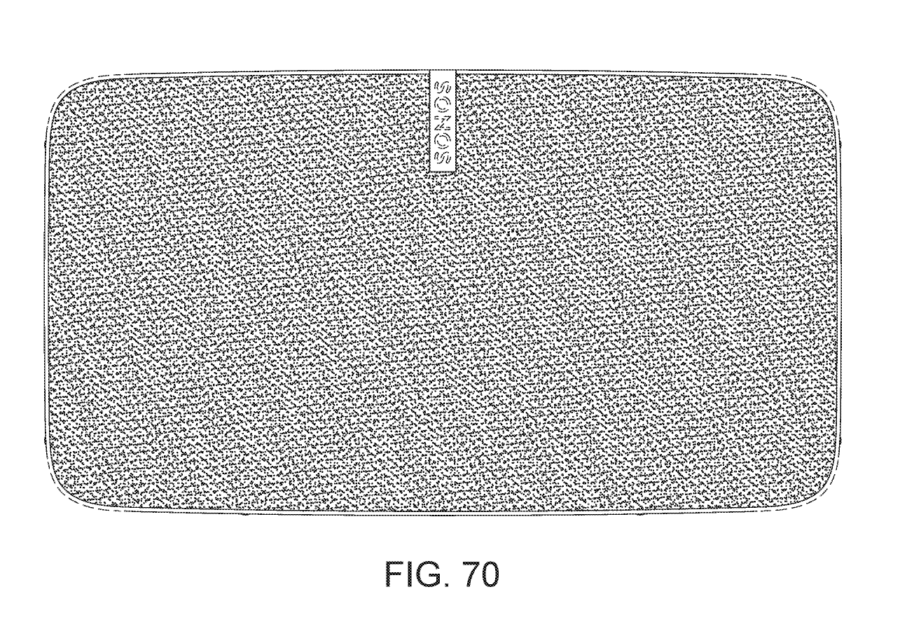

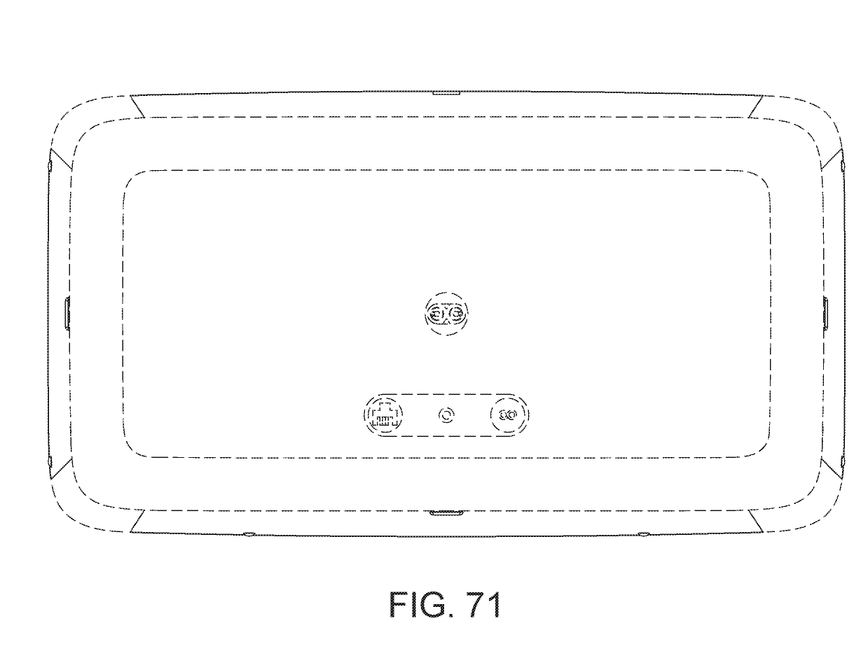

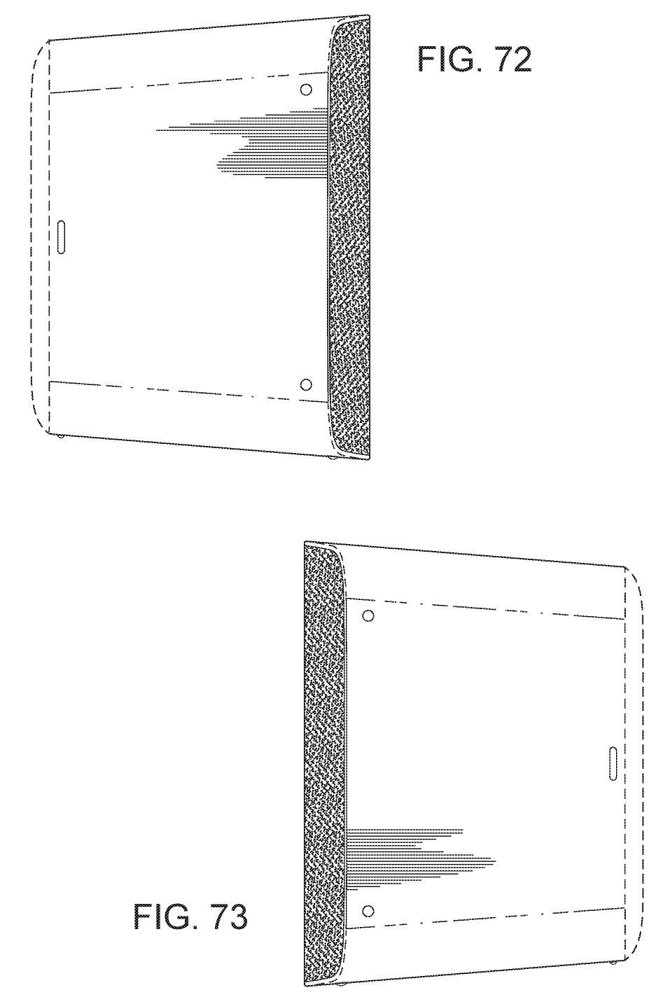

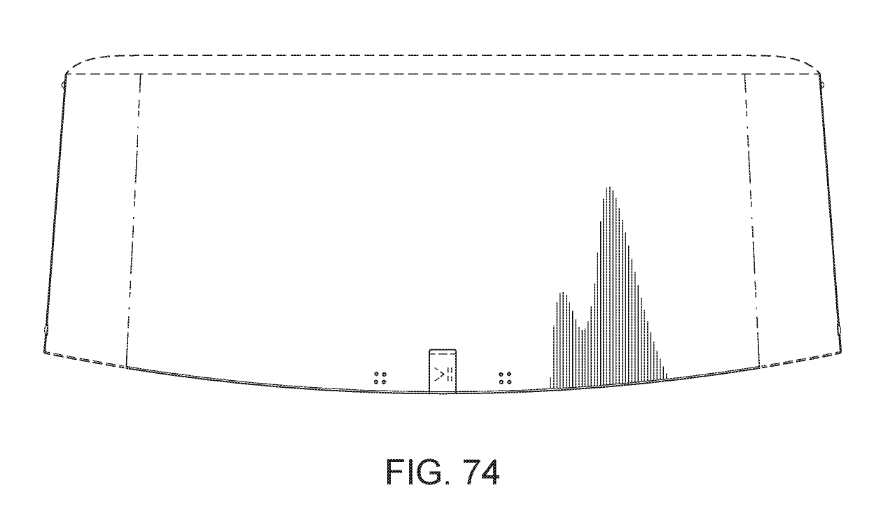

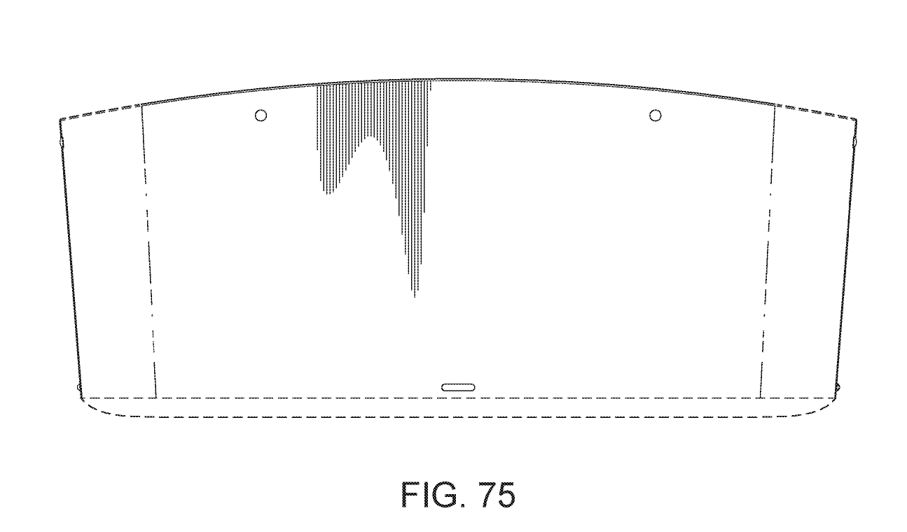

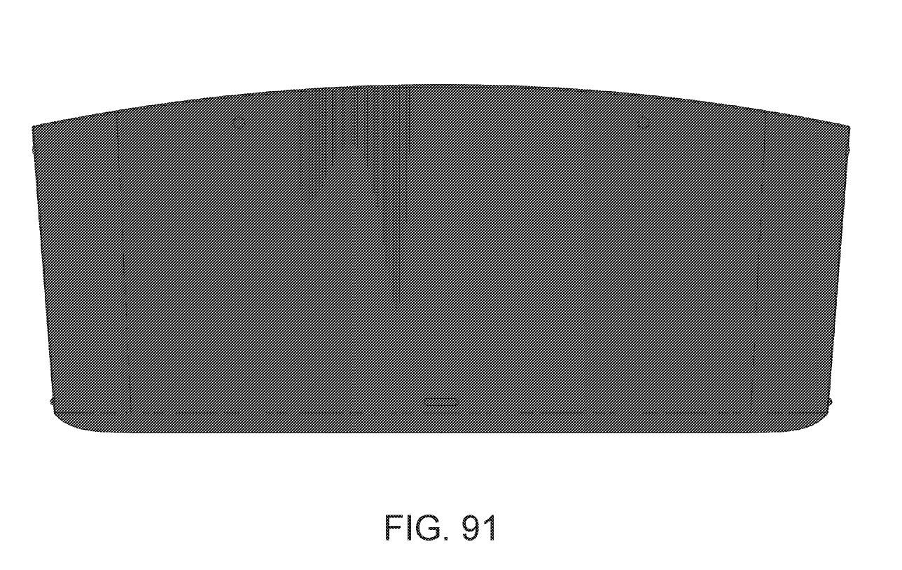

Turning now to the drawings, the figures illustrate a number of new, original, and ornamental designs for playback devices. The inventive designs illustrated encompass a variety of combinations of the various features of the playback devices including (but not limited to) the color of the playback devices and the appearance of the feet of the playback device illustrated in FIGS. 1-91 utilized to stabilize the playback device when stood on end, when the feet of the playback device are visible due to the playback device being mounted on its base (as opposed to on end). Accordingly, various features of one or more of the illustrated embodiments may be the subject of a claim to a new original, and ornamental design for a playback device.

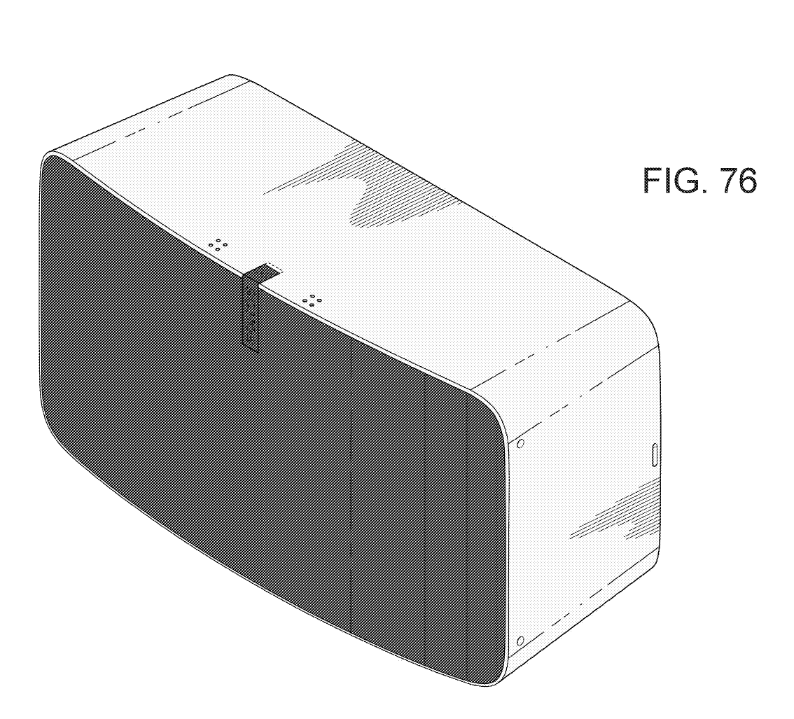

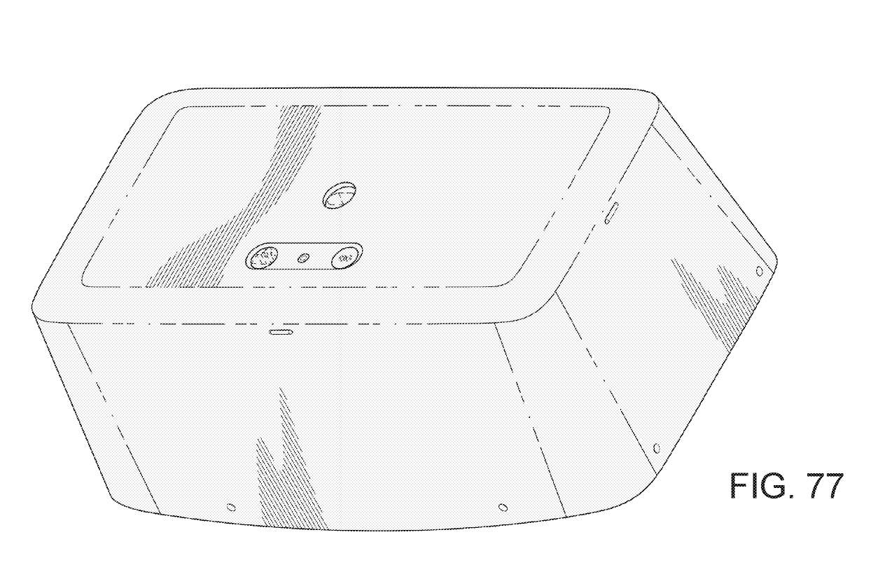

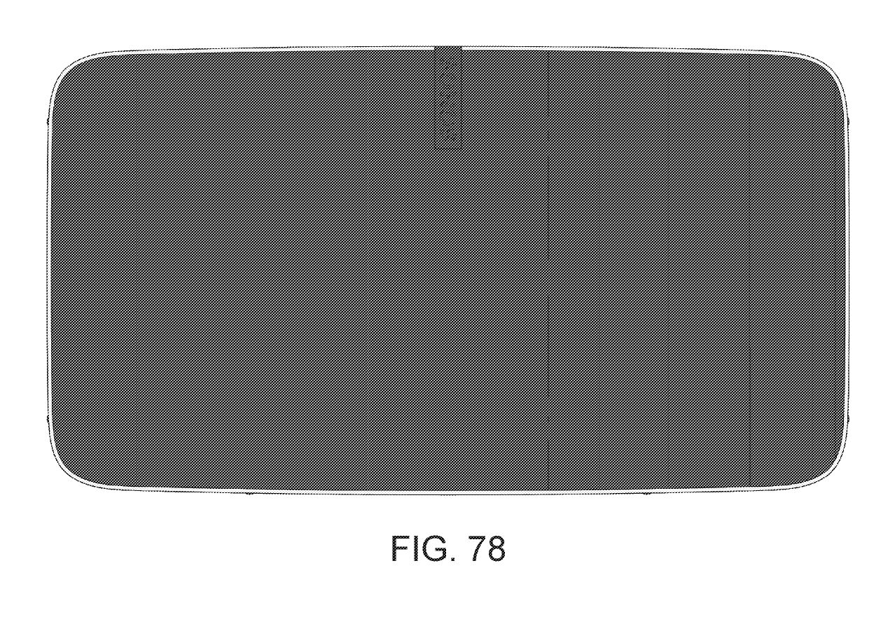

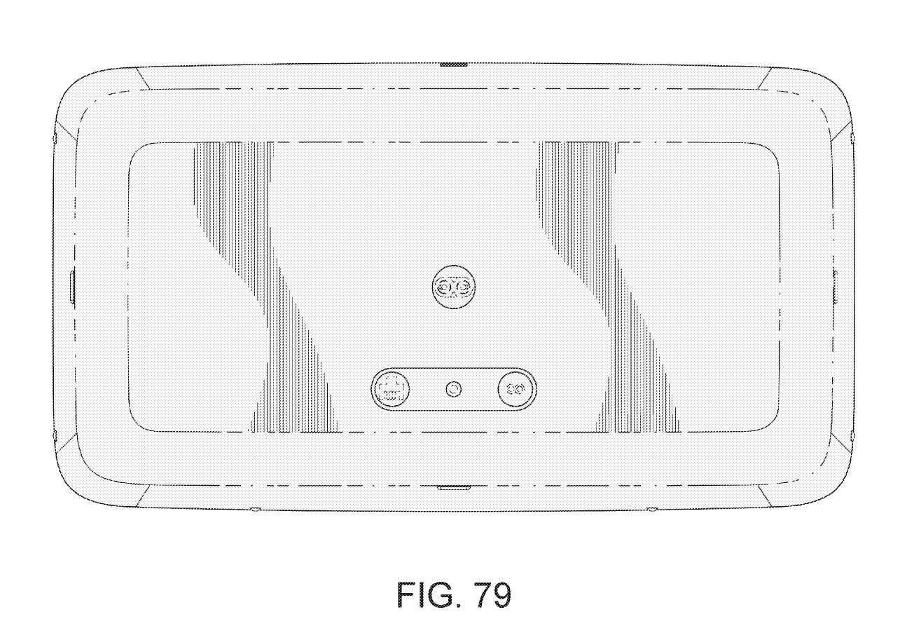

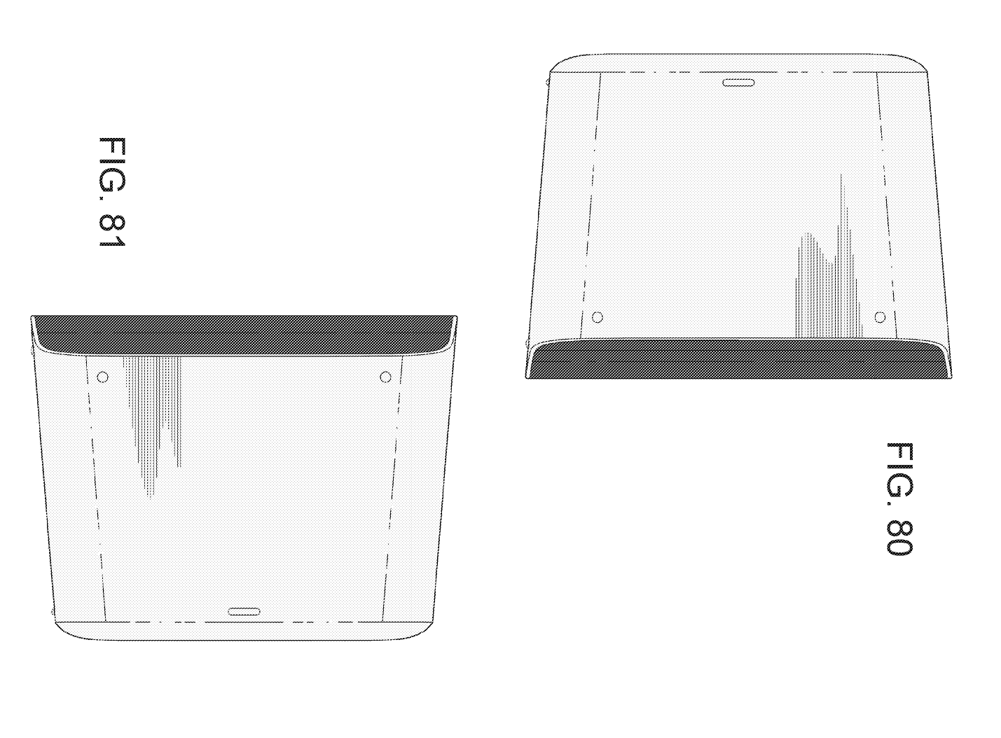

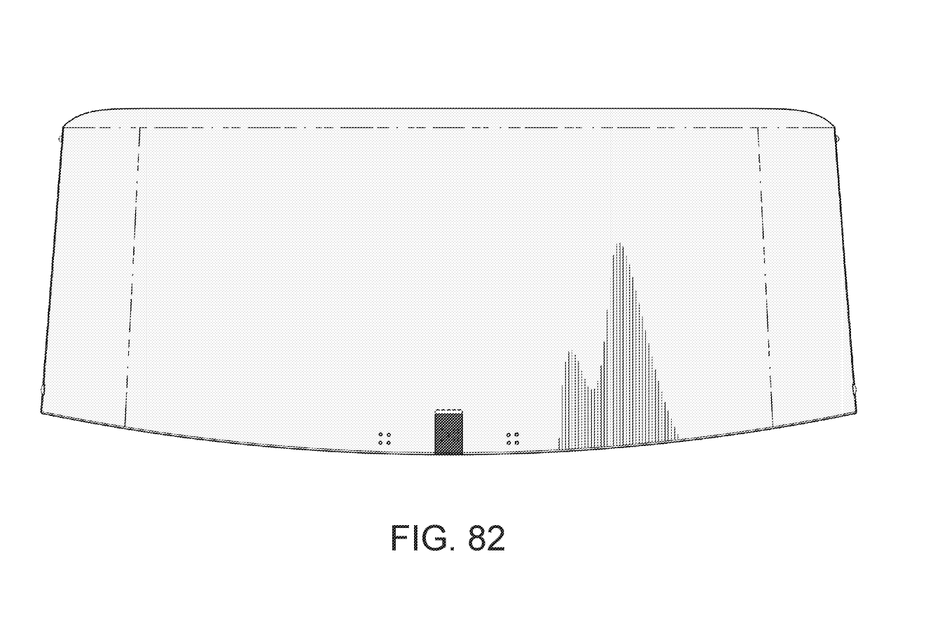

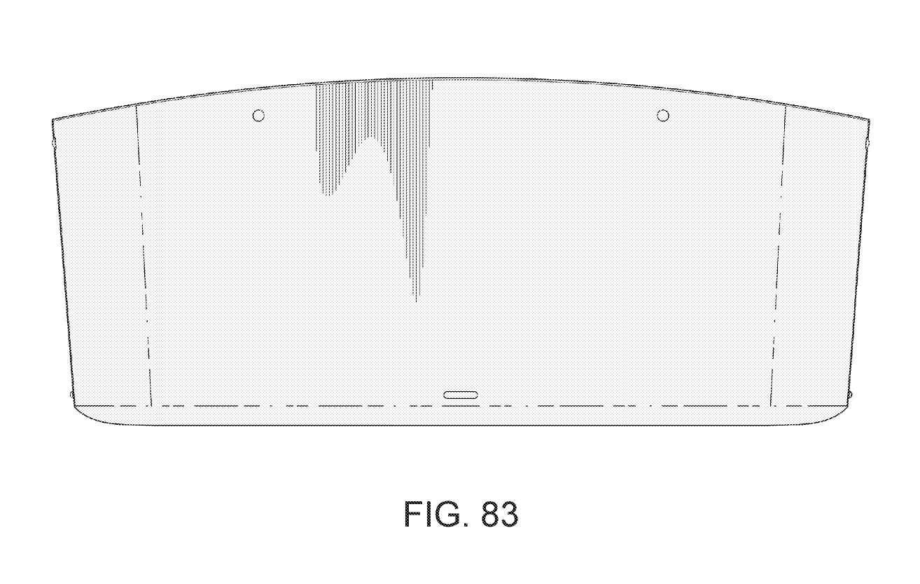

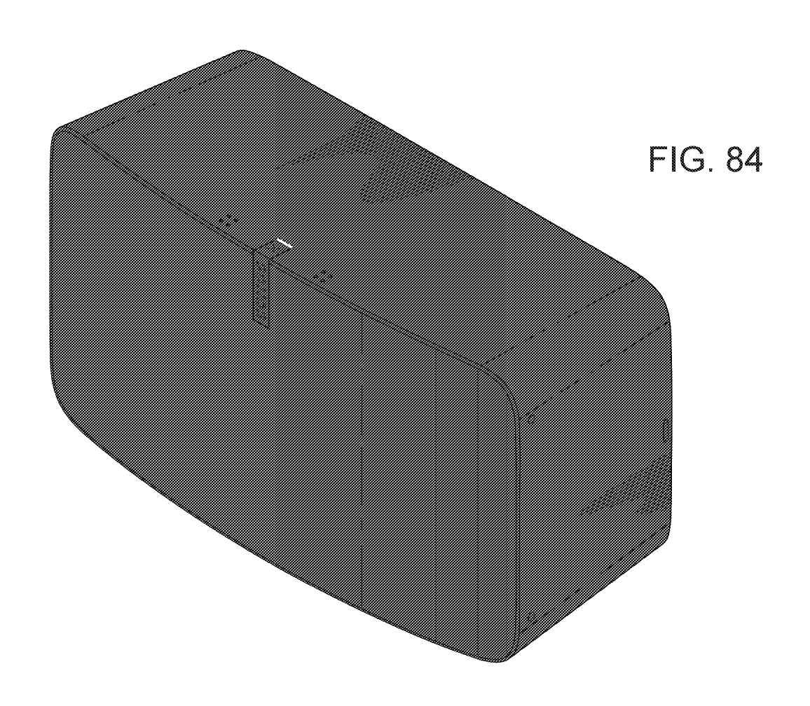

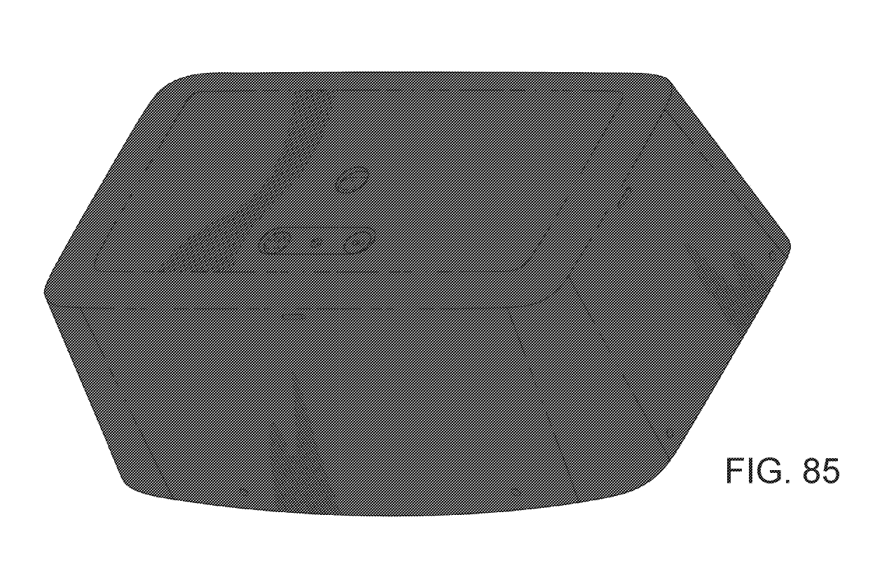

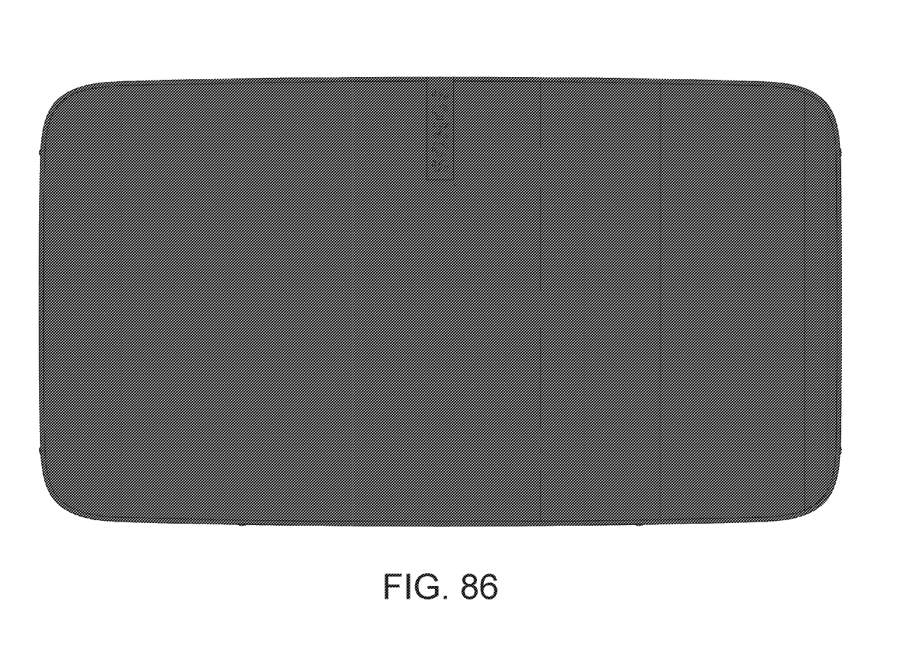

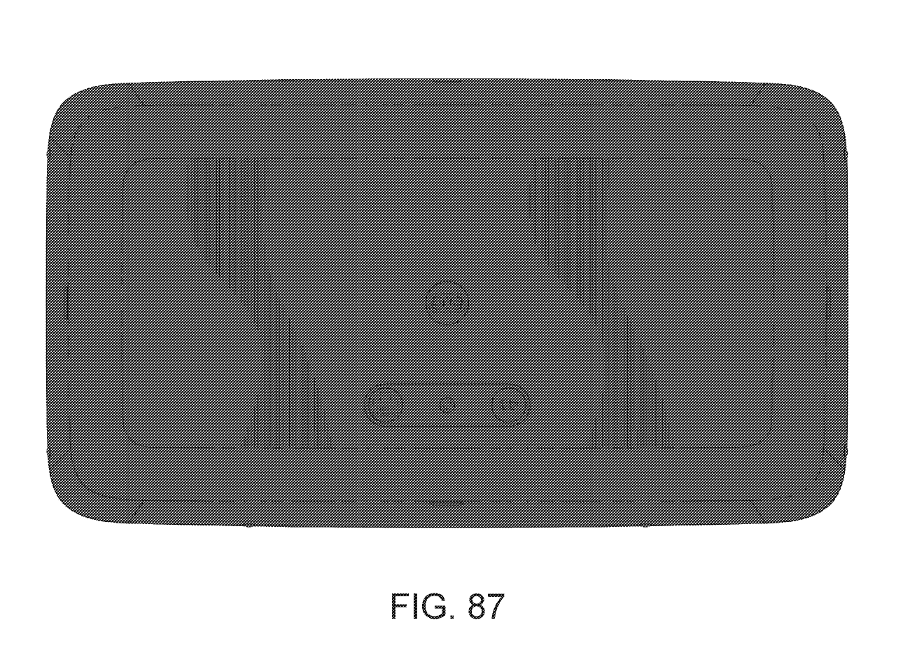

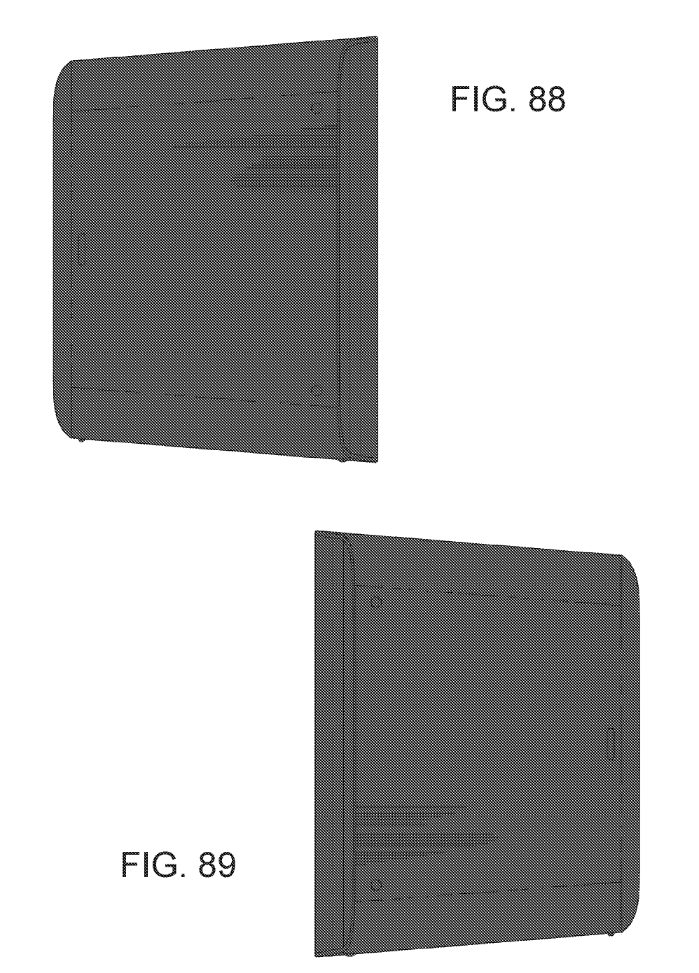

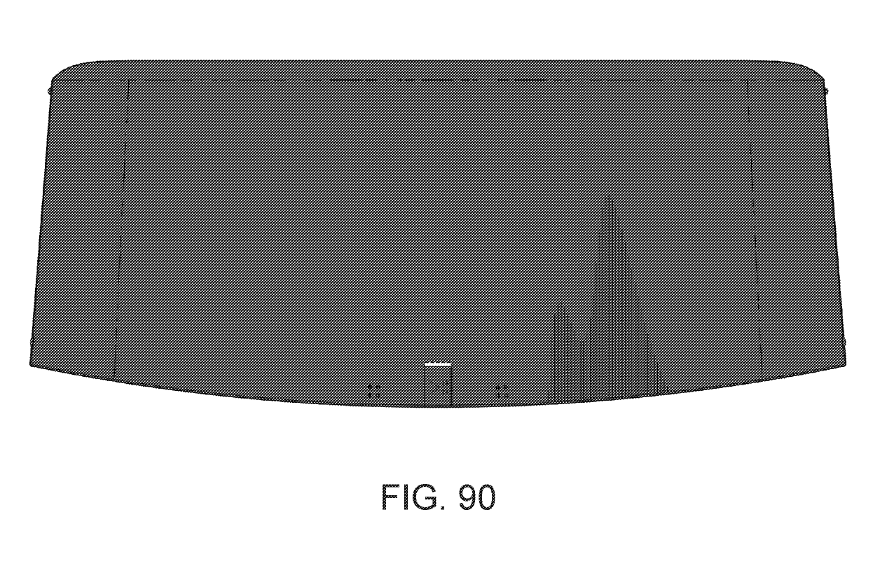

FIGS. 76-91 are executed in color. The pictured embodiments illustrate media players having a black outer casing with a slightly lighter black front speaker screen and black feet and white outer casing with a black front speaker screen and white feet. Symbols on the play/pause button are in white, the front brand logo “Sonos” is in white, and the attached power cord can be black or white. In various embodiments of the invention, one or more sides of the speaker case (such as the left and right sides and the bottom) include feet. Several embodiments include three feet on a side. One skilled in the art will recognize that variations of these colors and/or other colors may be utilized in accordance with embodiments of the invention.

Although the description above contains many specificities, these should not be construed as limiting the scope of the invention but as merely providing illustrations of some of the presently preferred embodiments of the invention. Various other embodiments are possible within its scope.

1. A playback device comprising:
an outer casing having six sides, where a front side includes a speaker screen, a bottom side adjacent to the front side includes three feet, a left side adjacent to the front side and to the bottom side includes three feet, and a right side adjacent to the front side and the bottom side includes three feet.
